(19) United States
(12) Patent Application Publication
(10) Pub. No.: US 2019/0099991 A1
(43) Pub. Date: Apr. 4, 2019

(54) MULTILAYER ARTICLES WITH A BARRIER FILM INCLUDING A THERMOPLASTIC ALIPHATIC POLYESTER, A POLYVINYL ALKANOATE POLYMER, AND A PLASTICIZER

(71) Applicant: 3M INNOVATIVE PROPERTIES COMPANY, SAINT PAUL, MN (US)

(72) Inventors: Ning Zhou, Vadnias Heights, MN (US); Haoming Rong, Woodbury, MN (US); Korey W. Karls, Woodbury, MN (US); Matthew T. Scholz, Woodbury, MN (US); Daniel R. McIntyre, Woodbury, MN (US); Derek J. Dehn, Maplewood, MN (US)

(73) Assignee: 3M INNOVATIVE PROPERTIES COMPANY, SAINT PAUL, MN (US)

(21) Appl. No.: 16/088,909

(22) PCT Filed: Jun. 13, 2017
(86) PCT No.: PCT/US2017/037121

§ 371 Date: Sep. 27, 2018

Related U.S. Application Data
(60) Provisional application No. 62/353,492, filed on Jun. 22, 2016.
(60) Provisional application No. 62/353,998, filed on Jun. 23, 2016.

(51) Int. Cl. B32B 27/12; B32B 27/36; B32B 27/22; B32B 37/22

(52) U.S. Cl. CPC B32B 27/12; B32B 27/36; B32B 2535/00; B32B 37/223; B32B 27/22

(57) ABSTRACT

Multilayer articles include a fibrous web and a barrier film directly bonded to the fibrous web; wherein the fibrous web includes fibers that include natural fibers, synthetic fibers, or combinations thereof; wherein the synthetic fibers comprise a synthetic thermoplastic polymer selected from an aliphatic polyester, an aromatic polyester, a polyamide, and combinations thereof; and wherein the barrier film includes a thermoplastic aliphatic polyester, a polyvinyl alkanoate polymer having a Tg of no greater than 70 C; and a non-lactide plasticizer having an acid number of no greater than 10 and having a weight average molecular weight of no greater than 5000 g/mol.

### BACKGROUND

Poly(lactic acid) (referred to herein as “PLA”) is becoming an important industrial raw material because it is a biodegradable plastic that is not derived from petroleum. PLA is a renewable resource that is derived from corn, potatoes, and various plants. PLA is referred to as a carbon circulation-type plastic because it is produced from lactic acid and after use can be broken down to water and carbon dioxide through biodegradation or incineration.

PLA has a mechanical strength at room temperature that is close to that of polyethylene terephthalate (PET), and is easily manipulated. Because of these characteristics, PLA is expected to become a general-purpose plastic material that is commonly used in daily life. PLA does, however, have drawbacks based on its heat resistance, fragility, and low flexibility.

Modifications of PLA-containing materials are needed to make them useful in a variety of applications, particularly multilayer articles.

### SUMMARY

The present disclosure provides multilayer articles that include a barrier film. The barrier film includes a thermoplastic aliphatic polyester, a polyvinyl alkanoate polymer (e.g., polyvinyl acetate polymer), and a plasticizer.

In one embodiment, a multilayer article is provided that includes a fibrous web and a barrier film directly bonded (typically, directly thermally bonded) to the fibrous web. The fibrous web includes fibers that include natural fibers, synthetic fibers, or combinations thereof; wherein the synthetic fibers comprise a synthetic thermoplastic polymer selected from an aliphatic polyester, an aromatic polyester, a polyamide, and combinations thereof. The barrier film includes a thermoplastic aliphatic polyester, a polyvinyl alkanoate polymer (e.g., polyvinyl acetate polymer) having a Tg of no greater than 70° C.; and a non-lactide plasticizer having an acid number of no greater than 10 and having a weight average molecular weight of no greater than 5000 g/mol.

The terms “glass transition temperature” and “Tg” are used interchangeably. Typically T_{g} values are measure using Differential Scanning calorimetry (DSC) unless otherwise noted.

The phrase “directly bonded” in the context of the barrier film and the fibrous web means that there is no tie layer or adhesive layer disposed between the barrier film and the fibrous web.

The term “barrier film” refers to a film (that may include one or more layers) that does not allow liquid water to pass through at a pressure of 5 kPa (50 millibars) when tested by the Hydrohead Method as described in EN 20811-1993 Textiles-Determination of Resistance to Water Penetration-Hydrostatic Pressure Test. For laminates of a fibrous web and a barrier film the fibrous web side of a laminate is placed in contact with the water during this test. In certain embodiments, barrier films exceed 7.5 kPa or even 10 kPa when tested by this method. In certain embodiments, barrier films do not allow liquid water to pass through when tested by the Hydrohead Method as described in EN 20811-1993 at 6 kPa per minute pressure increase with the barrier side up and no other support.

Herein, the terms “comprises” and “includes” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “includes at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain situations, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C. or 22° C. to 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### DETAILED DESCRIPTION OF ILLUSTRATIVE EMBODIMENTS

The present disclosure provides multilayer articles that include a barrier film and a fibrous web, wherein the barrier film is directly bonded to the fibrous web.

Exemplary embodiments of the multilayer articles according to the present disclosure may have structural features that enable their use in a variety of applications. Exemplary multilayer articles include a surgical drape, a surgical gown, a sterilization wrap, an absorbent pad such as that used under a patient to absorb fluid, a patient warming device, a sound absorption article, a thermal insulation article, a surface cleaning article, a cellular growth support article, a drug delivery article, a personal hygiene article, a wound dressing article, and a dental hygiene article. Preferred multilayer articles include a surgical drape, a surgical gown, a sterilization wrap, an absorbent pad such as that used under a patient to absorb fluid, a patient warming device, Examples of exemplary patient warming devices include warming blankets, warming pads, and warming garments, such as those described in International Pat. Pub. No. WO 2016/069551.

Exemplary embodiments of the fibrous webs of the multilayer articles according to the present disclosure may have exceptional absorbent properties, may exhibit high porosity and permeability due to their low solidity, may be dimensionally stable, and/or may be manufactured in a cost-effective manner.

In certain embodiments, multilayer articles of the present disclosure have a stiffness of no greater than 7.0 Newtons (N), or no greater than 6.0 N, or no greater than 5.0 N, according to ASTM D4032-08. In certain embodiments, multilayer articles of the present disclosure have a stiffness of at least 1.0 N, according to ASTM D4032-08.

In certain embodiments, multilayer articles of the present disclosure are “quiet” in that they have no crunching noise upon handling (like paper).

In certain embodiments, multilayer articles of the present disclosure are “soft” in that they have a soft hand feel, do not audibly crinkle when balled up in a hand, and are drapable upon handling. In part, this is due to the presence of small diameter fibers in the fibrous web (as described herein). The fibrous webs of the multilayer articles of the present disclosure may have a soft feel similar to that of polyolefin webs, but in many cases exhibit superior tensile strength due to the higher modulus of the polymer used to make the fibers.

Multilayer articles of the present disclosure include a fibrous web and a barrier film directly bonded to the fibrous web. That is, there is no intervening adhesive or tie layer. In certain embodiments, the barrier film is directly bonded to the hydrophilic absorbent layer by thermally bonding. Thermal bonding can typically be carried out by extrusion coating, thermally laminating (e.g., calendering), ultrasonic bonding, RF welding, and the like.

The fibrous web includes fibers that include natural fibers, synthetic fibers, or combinations thereof; wherein the synthetic fibers comprise a synthetic thermoplastic polymer selected from an aliphatic polyester, an aromatic polyester, a polyamide, and combinations thereof.

The barrier film includes a thermoplastic aliphatic polyester, a polyvinyl alkanoate (e.g., a polyvinyl acetate) polymer having a Tg of no greater than 70° C.; and a non-lactide plasticizer having an acid number of no greater than 10 and having a weight average molecular weight of no greater than 5000 g/mol.

In certain embodiments, the barrier film does not exhibit plasticizer migration when aged at elevated temperature (e.g., 70° C. or 80° C.) for 24 hours. In this context, plasticizer migration forms an oily film that can be detected by an Ink Migration Test that involves writing on the barrier layer with a SHARPIE brand felt tip permanent marker without the ink of the pen running or smearing after a period of aging the samples at elevated temperature. According to this test, ink smearing can be noticed without being wiped by a finger.

In certain embodiments, the barrier film has a net melting endotherm for a first heating scan, ΔHₙₘ₁, of greater than 10 Joules per gram (J/g).

In certain embodiments, the barrier film has a Tg of less than 30° C., or less than 25° C., or less than 20° C., or less than 15° C., or less than 10° C.

In certain embodiments, the barrier film has a tensile elongation of at least 50%. In certain embodiments, the barrier film has a tensile elongation of up to 600% at room temperature.

In certain embodiments, the barrier film has a tensile modulus of at least 50 megaPascals (MPa). In certain embodiments, the barrier film has a tensile modulus of up to 500 MPa.

### Fibrous Web

In certain embodiments, the fibrous web is instantaneously absorbent to water. In this context, “instantaneously absorbent” refers to a fibrous web such that when a 200 μL drop of water is gently placed on an expanse of the fibrous web on a horizontal surface it is completely absorbed in less than 10 seconds, preferably less than 5 seconds, and most preferably less than 3 seconds.

In certain embodiments, the fibrous web includes woven and nonwoven webs. In certain embodiments, the nonwoven web is selected from a melt-blown web, a spun-bond web, a spun-laced web, a wet-laid web, a dry-laid web, an electro-spun web, a hydroentangled web, and a combination thereof (e.g., spun-bond/melt-blown/spun-bond combinations, spun-bond/melt-blown/melt-blown/spun-bond combinations, spun-bond/melt-blown/spun-bond/melt-blown/spun-bond combinations, and spun-bond/melt-blown/melt-blown/melt-blown/spun-bond combinations).

The fibrous web of the multilayer articles of the present disclosure includes fibers that are made from one or more polymers, including natural polymer fibers, synthetic polymer fibers, or combinations thereof. The synthetic fibers may include a synthetic thermoplastic polymer selected from an aliphatic polyester, an aromatic polyester, a polyamide, or combinations thereof.

In certain embodiments, the individual fibers of the fibrous web and/or the fibrous web may include one or more additives, including a surfactant, a surfactant carrier, a viscosity modifier, an antishrinkage additive, an antimicrobial agent, an antimicrobial agent enhancer, an antistatic agent, a plasticizer, a diluent, or combinations thereof.

In certain embodiments, the fibrous webs of the multilayer articles of the present disclosure may include coarse fibers, fine fibers, or both coarse and fine fibers. In certain embodiments, such fibers may be formed by use of a viscosity modifier (as described herein) to reduce the viscosity of polymer(s) forming the fibers (e.g., aliphatic polyesters, such as PLA).

In certain embodiments, the fibrous web may include fine fibers. In this context, fine fibers are sub-micrometer fibers having a median fiber diameter of less than 1 micrometer (μm). Thus, in certain exemplary embodiments, the fibers exhibit a median diameter of less than 1 μm, or no greater than 0.9 μm, or no greater than 0.7 μm. In certain embodiments, the sub-micrometer fibers have a median fiber diameter of at least 0.2 μm, or at least 0.5 μm.

In certain embodiments, the fibrous web may include coarse fibers. In this context, coarse fibers have a median fiber diameter of at least 1 μm. Thus, in certain exemplary embodiments, the fibers exhibit a median diameter of at least 1 μm, or at least 5 μm, or least 10 μm, or at least 20 μm, or at least 25 μm. In certain embodiments, the coarse fibers of the fibrous web exhibit a median fiber diameter of no greater than 100 μm, or no greater than 50 μm, or no greater than 25 μm, or no greater than 20 μm, or no greater than 15 μm, or no greater than 10 μm, or no greater than 5 μm.

In certain embodiments, the fibrous web is biocompatible. The term “biocompatible” means biologically compatible by not producing toxic, injurious or immunological response in living tissue. Biocompatible materials may also be broken down by biochemical and/or hydrolytic processes and absorbed by living tissue.

The fibers of the fibrous web may be monocomponent fibers or multicomponent fibers. Among other benefits, the ability to use monocomponent fibers reduces complexity of manufacturing and places fewer limitations on use of the web. The multicomponent fibers may be in a variety of configurations, including core-sheath, islands-in-the-sea, segmented pie, or side-by-side. Multicomponent fibers are advantageous in that they can provide different properties to different portions of individual fibers (e.g., a different melt temperature for the core as compared to the sheath). The multicomponent fibers may include one or more polymers and optionally one or more additives as described herein.

In certain embodiments, the fibrous web is dimensionally stable. By this it is meant that the fibrous web has at least one dimension that decreases by no greater than 10% in the plane of the web when the web is heated to a temperature above a glass transition temperature of the fibers, but below the melting point of the fibers. In certain embodiments, such dimensional stability results from incorporation of one or more antishrinkage additives, as described herein.

Dimensional stability of the fibrous web and of the barrier film are typically matched to a significant degree such that the multilayer article does not buckle, wrinkle, or curl such that it is noticeable on a 50 cm square drape placed over a 40 mm×90 mm×75 cm board (standard U.S. “2×4” that is 3 feet long).

In certain embodiments, for example, the fibrous web of the multilayer articles of the present disclosure may further include a surfactant. In certain embodiments, the surfactant may be incorporated in (e.g., blended in) the polymer of the fibers. Alternatively, in certain embodiments, the surfactant may be disposed on the fibers (individually or as a yarn such as a sizing) and/or disposed on the fibrous web. In certain embodiments, the fibers may be in a core/sheath arrangement, wherein the core includes the polymer, and the sheath includes the polymer and the surfactant. This increases the tensile strength of the fiber by increasing the crystallinity of the core.

In certain embodiments, the fibrous web of the multilayer articles of the present disclosure may further include a nonvolatile surfactant carrier. Such nonvolatile surfactant carrier may be particularly desirable when the surfactant is incorporated in the synthetic polymer of the fibers of the fibrous web. Typically, the surfactant is predissolved in a nonvolatile carrier.

In some exemplary embodiments, the fibrous web is formed from a molten system. For example, the fibrous web may be made by forming a mixture of one or more thermoplastic polyesters selected from aliphatic polyesters and aromatic polyesters with polypropylene in an amount greater than 0% and no more than 10% by weight of the mixture; forming a plurality of fibers from the mixture; and collecting at least a portion of the fibers to form a web, wherein the fibers exhibit molecular orientation and extend substantially endlessly through the web, and further wherein the web has at least one dimension in the plane of the web which decreases by no greater than 10% when the web is heated to a temperature above a glass transition temperature of the fibers, but below the melting point of the fibers. In some embodiments, the fibers may be formed using melt-spinning, filament extrusion, electrospinning, gas jet fibrillation or combinations thereof.

In another example, the fibrous web may be made by forming a mixture of one or more thermoplastic aliphatic polyesters with polypropylene in an amount greater than 0% and no more than 10% by weight of the mixture; forming a plurality of fibers from the mixture; and collecting at least a portion of the fibers to form a web, wherein the fibers do not exhibit molecular orientation, and further wherein the web has at least one dimension which decreases by no greater than 10% in the plane of the web when the web is heated to a temperature above a glass transition temperature of the fibers, but below the melting point of the fibers. In some exemplary embodiments, the fibers may be formed using a melt-blowing (e.g. BMF) process.

In some exemplary embodiments, the fibrous web may be made using a method that may further include post heating the fibrous web, for example, by controlled heating or cooling of the web.

In certain embodiments, the fibers of the fibrous webs are molecularly oriented fibers. In certain embodiments, dimensionally stable nonwoven fibrous webs can be prepared by fiber-forming processes in which filaments of fiber-forming material are formed by extrusion of a mixture of one or more thermoplastic polyesters selected from aliphatic and aromatic polyesters with polypropylene in an amount greater than 0% and no more than 10% by weight of the mixture, subjected to orienting forces, and passed through a turbulent field of gaseous currents while at least some of the extruded filaments are in a softened condition and reach their freezing temperature (e.g., the temperature at which the fiber-forming material of the filaments solidifies) while in the turbulent field. Such fiber formations processes include, for example, melt-spinning (i.e. spunbond), filament extrusion, electrospinning, gas jet fibrillation or combinations thereof.

The resulting webs have at least one dimension which decreases by no greater than 10% in the plane of the web when the web is heated to a temperature above a glass transition temperature of the fibers. The glass transition temperature of the fibers may be determined conventionally as is known in the art, for example, using differential scanning calorimetry (DSC), or modulated DSC. In certain exemplary embodiments, the thermoplastic polyester may be selected to include at least one aromatic polyester. In other exemplary embodiments, the aromatic polyester may be selected from PET, PETG, poly(butylene) terephthalate (PBT), poly(trimethyl) terephthalate (PTT), or combinations thereof.

As noted above, the fibers are preferably molecularly oriented; i.e., the fibers preferably comprise molecules that are aligned lengthwise of the fibers and are locked into (i.e., are thermally trapped into) that alignment. Oriented fibers are fibers where there is molecular orientation within the fiber. Fully oriented and partially oriented polymeric fibers are known and commercially available. Orientation of fibers can be measured in a number of ways, including birefringence, heat shrinkage, X-ray scattering, and elastic modulus (see e.g., Principles of Polymer Processing, Zehev Tadmor and Costas Gogos, John Wiley and Sons, New York, 1979, pp. 77-84). It is important to note that molecular orientation is distinct from crystallinity, as both crystalline and amorphous materials can exhibit molecular orientation independent from crystallization. Thus, even though commercially known sub-micrometer fibers made by melt-blowing or electrospinning are not oriented, there are known methods of imparting molecular orientation to fibers made using those processes.

Oriented fibers prepared according exemplary embodiments of the disclosure may show a difference in birefringence from segment to segment. By viewing a single fiber through a polarized microscope and estimating retardation number using the Michel-Levy chart (see, “On-Line Determination of Density and Crystallinity During Melt Spinning”, Vishal Bansal et al, Polymer Engineering and Science, November 1996, Vol. 36, No. 2, pp. 2785-2798), birefringence is obtained with the following formula: birefringence=retardation (nm)/1000D, where D is the fiber diameter in micrometers. Exemplary fibers susceptible to birefringence measurements generally include segments that differ in birefringence number by at least 5%, and preferably at least 10%. Some exemplary fibers may include segments that differ in birefringence number by 20 or even 50 percent. In some exemplary embodiments, the molecular orientation of the fibers results in a bi-refringence value of at least 0.00001, more preferably at least 0.0001, still more preferably at least 0.001, most preferably at least 0.01.

Different oriented fibers or portions of an oriented fiber also may exhibit differences in properties as measured by differential scanning calorimetry (DSC). For example, DSC tests on exemplary webs prepared according to the disclosure may reveal the presence of chain-extended crystallization by the presence of a dual melting peak. A higher-temperature peak may be obtained for the melting point for a chain-extended, or strain-induced, crystalline portion; and another, generally lower-temperature peak may occur at the melting point for a non-chain-extended, or less-ordered, crystalline portion. The term “peak” herein means that portion of a heating curve that is attributable to a single process, e.g., melting of a specific molecular portion of a fiber such as a chain-extended portion. The peaks may be sufficiently close to one another that one peak has the appearance of a shoulder of the curve defining the other peak, but they are still regarded as separate peaks, because they represent melting points of distinct molecular fractions.

In certain exemplary embodiments, the passive longitudinal segments of the fibers may be oriented to a degree exhibited by typical spunbond fibrous webs. In crystalline or semi-crystalline polymers, such segments preferably exhibit strain-induced or chain-extended crystallization (i.e., molecular chains within the fiber have a crystalline order aligned generally along the fiber axis). As a whole, the web can exhibit strength properties like those obtained in spunbond webs, while being strongly bondable in ways that a typical spunbond web cannot be bonded. And autogenously bonded webs of the invention can have a loft and uniformity through the web that are not available with the point-bonding or calendering generally used with spunbond webs.

While not intending to be bound by theory, it is believed that molecular orientation is improved through the use of fiber attenuation as is known in the art (See U. W. Gedde, Polymer Physics, 1st Ed. Chapman & Hall, London, 1995, 298). An increase in percent crystallinity of the attenuated fibers may thus be observed. The crystallites stabilize the filaments by acting as anchoring which inhibit chain motion, and rearrangement and crystallization of the rigid amorphous fraction; as the percentage of crystallinity is increased the rigid amorphous and amorphous fraction is decreased. Semi-crystalline, linear polymers consist of a crystalline and an amorphous phase with both phases being connected by tie molecules. The tie-molecule appears in both phases; strain builds at the coupled interface and it appears particularly obvious in the amorphous phase as observed in the broadening of the glass transition to higher temperatures in semi-crystalline polymers. In cases of strong coupling, the affected molecular segments are produce a separate intermediate phase of the amorphous phase called the rigid amorphous fraction. The intermediate phase, forming the extended boundary between the crystalline and amorphous phases, is characterized by lower local entropy than that of the fully amorphous phase.

### Polymer of the Fibers in the Fibrous Web

The fibrous web of the multilayer articles of the present disclosure includes fibers that include natural fibers, synthetic fibers, or combinations thereof. The synthetic fibers may include a synthetic thermoplastic polymer selected from an aliphatic polyester, an aromatic polyester, a polyamide, or combinations thereof.

In certain embodiments, the fibrous web includes natural fibers. In certain embodiments, the natural fibers are selected from bamboo fibers, soy bean fibers, agave fibers, coco fibers, rayon fibers, cellulosic fibers, wood pulp fibers, cotton fibers, hemp fibers, ramie fibers, rattan fibers, vine fibers, kenaf fibers, flax fibers, jute fibers, silk fibers, wool fibers, other animal derived fibers, and derivatives and combinations thereof. Derivatives of such natural fibers include regenerated cellulose, such as rayon and fibril rayon, esters such as semi-synthetic cellulose (e.g., acetate and triacetate), sulfonated or carboxylated derivatives, and the like.

In certain embodiments, the fibrous web includes fibers made of a synthetic thermoplastic polymer. In certain embodiments, a thermoplastic polymer is selected from an aromatic polyester, a polyamide, an aliphatic polyester, or combinations thereof.

In certain embodiments, the synthetic thermoplastic polymer is an aromatic polyester. Examples of suitable aromatic polyesters for use in the fibrous web include a poly(ethylene) terephthalate (PET), a poly(ethylene) terephthalate glycol (PETG), a poly(butylene) terephthalate (PBT), a poly(trimethyl) terephthalate (PTT), and combinations thereof.

In certain embodiments, the synthetic thermoplastic polymer is a polyamide. Examples of suitable polyamides for use in the fibrous web include nylon-6, nylon-7, nylon-8, nylon-9, nylon-10, nylon-11, nylon-12, nylon-13, nylon-14, nylon-15, nylon-16, nylon-17, nylon-18, nylon-6,6, nylon-6,8, nylon-6,10, nylon-6,12, nylon-6,14, nylon-8,8, nylon-8,10, nylon-8,12, nylon-8,14, nylon-10,10, nylon-10,12, nylon-8,12, nylon-10,14, nylon-12,12, nylon-12,14, nylon-14,16, and combinations thereof. In certain embodiments, the polyamide is selected from the group of nylon-6, nylon-6,6, and combinations thereof.

In certain embodiments, the fibrous web described herein includes a thermoplastic aliphatic polyester.

In certain embodiments, the thermoplastic aliphatic polyester of the fibrous web is selected from a poly(lactic acid), a poly(glycolic acid), a poly(lactic-co-glycolic acid), a polyalkylene succinate such as polybutylene succinate, a polyalkylene adipate, a polyhydroxybutyrate, a polyhydroxyvalerate, and combinations thereof.

In certain embodiments, the fibrous web described herein includes poly(lactic acid) (“PLA”) polymer. Lactic acid is a renewable material obtained by the bacterial fermentation of corn starch or cane sugar, and thus is considered a natural (or in other words) “biomass” material. Lactic acid has two optical isomers: L-lactic acid (also known as (S)-lactic acid) and D-lactic acid (also known as (R)-lactic acid), depicted as follows:

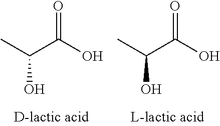

Polyesterification of lactic acid affords poly(lactic acid) polymer.

More typically, lactic acid is typically converted to the cyclic lactide monomer, and the lactide undergoes ring opening polymerization, such as depicted as follows:

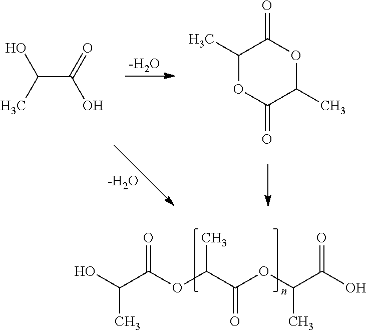

The resulting polymer material is typically referred to as polylactide polymer.

The degree of crystallinity is largely controlled by the ratio of D and/or meso-lactide to L cyclic lactide monomer used. Likewise, for polymers prepared by direct polyesterification of lactic acid, the degree of crystallinity is largely controlled by the ratio of polymerized units derived from D-lactic acid to polymerized units derived from L-lactic acid.

The fibrous web described herein generally includes a semicrystalline PLA polymer alone or in combination with an amorphous PLA polymer. Both the semicrystalline and amorphous PLA polymers generally include high concentrations of polymerized units derived from L-lactic acid (e.g., L-lactide) with low concentrations of polymerized units derived from D-lactic acid (e.g., D-lactide).

The semicrystalline PLA polymer typically includes at least 90 wt-%, at least 91 wt-%, at least 92 wt-%, at least 93 wt-%, at least 94 wt-%, at least 95 wt-%, at least 96 wt-%, at least 97 wt-%, or at least 98 wt-% of polymerized units derived from a single isomer. In certain embodiments, the single isomer is L-lactic acid. In some embodiments, the single isomer is D-lactic acid.

The semicrystalline PLA polymer typically includes at least 90 wt-%, at least 91 wt-%, at least 92 wt-%, at least 93 wt-%, at least 94 wt-%, at least 95 wt-%, at least 96 wt-%, at least 97 wt-%, or at least 98 wt-% of polymerized units derived from L-lactic acid (e.g., L-lactide) and no greater than 10 wt-%, no greater than 9 wt-%, no greater than 8 wt-%, no greater than 7 wt-%, no greater than 6 wt-%, or no greater than 5 wt-% of polymerized units derived from D-lactic acid (e.g., D-lactide and/or meso-lactide). In yet other embodiments, the semicrystalline PLA polymer includes at least 96 wt-% of polymerized units derived from L-lactic acid (e.g., L-lactide) and less than 4 wt-%, less than 3 wt-%, or less than 2 wt-% of polymerized units derived from D-lactic acid (e.g., D-lactide and/or meso-lactide).

Alternatively, the semicrystalline PLA polymer typically includes at least 90 wt-%, at least 91 wt-%, at least 92 wt-%, at least 93 wt-%, at least 94 wt-%, at least 95 wt-%, at least 96 wt-%, at least 97 wt-%, or at least 98 wt-% of polymerized units derived from D-lactic acid (e.g., D-lactide) and no greater than 10 wt-%, no greater than 9 wt-%, no greater than 8 wt-%, no greater than 7 wt-%, no greater than 6 wt-%, or no greater than 5 wt-% of polymerized units derived from L-lactic acid (e.g., L-lactide and/or meso-lactide).

In yet other embodiments, the semicrystalline PLA polymer includes a mixture of two polylactic acid polymers wherein the first polymer is derived from at least 96 wt-% (and preferably at least 97% and more preferably at least 98%) of polymerized units derived from L-lactic acid and the second polymer is derived from at least 96% (and preferably at least 97% and more preferably at least 98%) D-lactide.

The fibrous web may include an even lower concentration of polymerized units derived from D-lactic acid (e.g., D-lactide and/or meso-lactide) depending on the concentration of semicrystalline PLA polymer in the fibrous web. For example, if the barrier film and/or fibrous web includes 15 wt-% of a semicrystalline PLA having 2 wt-% D-lactide and/or meso-lactide, the fibrous web would include 0.3 wt-% D-lactide and/or meso-lactide. The barrier film and/or fibrous web may include no greater than 9 wt-%, no greater than 8 wt-%, no greater than 7 wt-%, no greater than 6 wt-%, no greater than 5 wt-%, no greater than 4 wt-%, no greater than 3 wt-%, no greater than 2 wt-%, no greater than 1.5 wt-%, no greater than 1.0 wt-%, no greater than 0.5 wt-%, no greater than 0.4 wt-%, no greater than 0.3 wt-%, no greater than 0.2 wt-%, or no greater than 0.1 wt-% polymerized units derived from D-lactic acid (e.g., D-lactide and/or meso-lactide). Suitable examples of semicrystalline PLA include that available from NatureWorks, LLC (Minnetonka, Minn.) under the trade designation INGEO 6202D and 6100D.

In certain embodiments, the fibrous web may include mixtures of monocomponent semicrystalline fibers and monocomponent amorphous fibers. In certain embodiments, individual fibers may include a semicrystalline portion and an amorphous portion. For example, individual fibers may be core-sheath fibers, wherein the sheath includes an amorphous portion (e.g., amorphous PLA), and the core includes a semicrystalline portion (e.g., semicrystalline PLA). Such multicomponent fibers are advantageous in that they can provide different properties to different portions of individual fibers (e.g., an amorphous PLA-containing sheath may have a lower melt temperature than that of a semicrystalline PLA-containing core).

### Optional Surfactants and Other Optional Additives in the Fibrous Web

In certain embodiments, the individual fibers of the fibrous web and/or the fibrous web may include one or more additives, including a surfactant, a surfactant carrier, a viscosity modifier, an antishrinkage additive, an antimicrobial agent, an antimicrobial agent enhancer, an antistatic agent, a diluent, or combinations thereof.

In certain embodiments, the fibrous web of the multilayer articles of the present disclosure may further include a surfactant, particularly if the polymer of the fibers of the fibrous web is not naturally hydrophilic. Examples of naturally hydrophilic polymers include those in natural fibers, such as cellulose fibers.

As used herein, the term “surfactant” means an amphiphile (a molecule possessing both polar and nonpolar regions which are covalently bound) capable of reducing the surface tension of water and/or the interfacial tension between water and an immiscible liquid. The term is meant to include soaps, detergents, emulsifiers, surface active agents, and the like. In applications in which biodegradability is important, it may be desirable to incorporate biodegradable surfactants, which typically include ester and/or amide groups that may be hydrolytically or enzymatically cleaved.

In certain embodiments, the surfactant may be incorporated in (e.g., blended in) the polymer of the fibers. Alternatively, in certain embodiments, the surfactant may be disposed on the fibers (individually) and/or disposed on the fibrous web. In certain embodiments, the fibers may be in a core/sheath arrangement, wherein the core includes the polymer, and the sheath includes the polymer and the surfactant.

In certain embodiments, suitable surfactants may include nonionic surfactants, anionic surfactants, cationic surfactants, zwitterionic surfactants, and combinations thereof. In certain embodiments, the surfactant is a nonionic surfactant. In certain embodiments, the surfactant includes a combination of a nonionic surfactant with an anionic surfactant or with a zwitterionic surfactant.

In certain embodiments, the anionic surfactant is selected from alkyl, alkenyl, alkaryl, arakyl, or alkylalkoxylated carboxylates, sulfonates, sulfates, phosphonates, phosphates, and combinations thereof. In certain embodiments, the anionic surfactant is selected from a (C8-C22)alkyl sulfate salt, a di(C8-C13 alkyl)sulfosuccinate salt, a (C8-C22)alkyl sarconsinate, a (C8-C22)alkyltaurate, a (C8-C22)alkyl lactylate, and combinations thereof.

In certain embodiments, the nonionic surfactant is a liquid at room temperature. In certain embodiments, the nonionic surfactant includes a branched alkyl chain, an unsaturated alkyl chain, a polyalkoxylate group, or a combination thereof. In certain embodiments, the nonionic surfactant is a polyalkoxylated nonionic surfactant. In certain embodiments, the polyalkoxylated nonionic surfactant is selected from an alkyl ether polyalkoxylate, an ethoxylated secondary alcohol, an alkyl ester polyalkoxylate, an alkyl amide polyalkoxylate, an alkoxylated sorbitan fatty ester, an alkoxylated ester of a polyhydric alcohol, an alkoxylated ether of a polyhydric alcohol, an alkyl polyglucoside, an alkyl polyglycerin ester, and combinations thereof.

In certain embodiments, a nonionic surfactant and an anionic surfactant are used in combination. In preferred embodiments of absorbent articles the nonionic surfactant is a liquid at room temperature.

In certain embodiments, one or more surfactants may be present in a total amount of at least 0.25 wt-%, based on the total weight of the fibrous web. Preferably the surfactant is present at a concentration of at least 0.5 wt-%, at least 1 wt-%, at least 1.5 wt-%, or at least 2 wt-%. In certain embodiments, one or more surfactants may be present in a total amount of no greater than 4 wt-%, no greater than 6 wt-%, no greater than 8 wt-%, no greater than 10 wt-%, or no greater than 15 wt-%, based on the total weight of the fibrous web.

In certain embodiments, the fibrous web may further include a nonvolatile surfactant carrier. Such nonvolatile surfactant carrier may be particularly desirable when the surfactant is incorporated into the synthetic polymer of the fibers of the fibrous web during melt processing. Typically, the surfactant is predissolved in a nonvolatile carrier. Nonvolatile carriers are those that do not lose more than 15 percent by weight when heated at 10° C./min to a temperature of at least 150° C. in a thermal gravimetric analysis (TGA).

In certain embodiments, the surfactant carrier is nonvolatile at processing temperatures, which may be as high as 150° C., 180° C., 200° C., or even as high as 250° C. Importantly, the carrier is typically thermally stable and can resist chemical breakdown and has an atmospheric boiling point higher than processing temperatures, which may be as high as 150° C., 180° C., 200° C. or even as high as 250° C.

In certain embodiments, the nonvolatile surfactant carrier is a liquid at room temperature. In a preferred embodiment, the surfactant carrier is a liquid at 23° C.

In certain embodiments, the nonvolatile surfactant carrier includes at least one of a polyalkylene oxide, a thermally stable polyhydric alcohol, a low molecular weight ester of a polyhydric alcohol, and combinations thereof.

In certain embodiments, the nonvolatile surfactant carrier is selected from polyethylene glycol, polypropylene glycol, random and block copolymers of ethylene oxide and propylene oxide, propylene glycol, glycerin, polyglycerin, triacetin, glyceryl caprylate/caprate, acetyltributylcitrate, and combinations thereof.

Preferred carriers include polyalkylene oxides such as polyethylene glycol, polypropylene glycol, random and block copolymers of ethylene oxide and propylene oxide, thermally stable polyhydric alcohols such as propylene glycol, glycerin, polyglycerin, and the like. The polyalkylene oxides may be linear or branched depending on the initiating polyol. For example, a polyethylene glycol initiated using ethylene glycol would be linear but one initiated with glycerin, trimethylolpropane, or pentaerythritol would be branched.

Preferred carriers also may include low molecular weight esters of polyhydric alcohols such as triacetin, glyceryl caprylate/caprate, acetyltributylcitrate, and the like.

The solubilizing liquids alternatively may be selected from nonvolatile organic solvents. For purposes of the present invention, an organic solvent is considered to be nonvolatile if greater than 80% of the solvent remains in the composition throughout the mixing and melt processes. Because these liquids remain in the melt processable composition, they function as plasticizers, generally lowering the glass transition temperature of the composition.

Since the carrier is substantially nonvolatile it will in large part remain in the composition and may function as an organic plasticizer. As used herein, a plasticizer is a compound having a molecular weight less than 1000 daltons which when added to the polymer composition results in a decrease in the glass transition temperature.

Suitable surfactant carriers include compounds containing one or more hydroxyl groups, and particularly glycols such glycerin; 1,2-pentanediol; 2,4-diethyl-1,5-pentanediol; 2-methyl-1,3-propanediol; as well as monofunctional compounds such 3-methoxy-methylbutanol (“MMB”). Additional examples of nonvolatile organic plasticizers include polyethers, including polyethoxylated phenols such as PYCAL 94 (phenoxypolyethyleneglycol); alkyl, aryl, and aralkyl ether glycols such as those sold under the DOWANOL tradename by Dow Chemical, including but not limited to, propyelene glycolmonobutyl ether (DOWANOL PnB, tripropyleneglycol monobutyl ether (DOWANOL TPnB), dipropyeleneglycol monobutyl ether (DOWANOL DPnB), propylene glycol monophenyl ether (DOWANOL PPH), propylene glycol monomethyl ether (DOWANOL PM); polyethoxylated alkyl phenols such as TRITON X35 and TRITON X102; mono or polysubstituted polyethylene glycols such as PEG 400 diethylhexanoate (TegMer 809, CP Hall), PEG 400 monolaurate (CHP-30N available from CP Hall) and PEG 400 monooleate (CPH-41N available from CPHall); amides such as higher alkyl substituted N-alkyl pyrrolidones such as N-octylpyrrolidone; sulfonamides such as N-butylbenzene sulfonamide (available from CP Hall), triglycerides, citrate esters, esters of tartaric acid, benzoate esters such as those available from Velsicol Chemical Corp., under the Benzoflex tradename including dipropylene glycoldibenzoate (BENZOFLEX 50), diethylene glycol dibenzoate, benzoic acid diester of 2,2,4-trimethyl-1,3-pentane diol (BENZOFLEX 354), ethylene glycol dibenzoate, tetraetheylene glycoldibenzoate, and the like; polyethylene glycols and ethylene oxide propylene oxide random and block copolymers having a molecular weight less than 10,000 daltons, preferably less than 5000 daltons, more preferably less than 2500 daltons, and combinations thereof. As used herein the term polyethylene glycols refers to glycols having 26 alcohol groups that have been reacted with ethylene oxide or a 2 haloethanol. Preferred polyethylene glycols are formed from ethylene glycol, propylene glycol, glycerin, trimethylolpropane, pentaerythritol, sucrose and the like. Most preferred polyethylene glycols are formed from ethylene glycol, propylene glycol, glycerin, and trimethylolpropane. Polyalkylene glycols such as polypropylene glycol, polytetramethylene glycol, or random or block copolymers of C2 to C4 alkylene oxide groups may also be selected as the plasticizer. Polyethylene glycols and derivatives thereof are presently preferred. It is important that the plasticizers be compatible with the polymer. For example, it is presently preferred to use nonvolatile nonpolymerizable plasticizers that have less than 2 nucleophilic groups such as hydroxyl groups when blended with polymers having acid functionality, since compounds having more than two nucleophilic groups may result in crosslinking of the composition in the extruder at the high extrusion temperatures. Importantly the non-volatile carriers preferably form a relatively homogeneous solution with the aliphatic polyester polymer composition in the extruder, and remains a relatively homogeneous composition upon cooling, such that the extruded composition is relatively uniform in surfactant concentration.

In certain embodiments, one or more nonvolatile surfactant carriers are present in a total amount of at least 0.1 wt-%, based on the total weight of the fibrous web. In certain embodiments, one or more nonvolatile surfactant carriers are present in a total amount of no greater than 10 wt-%, based on the total weight of the fibrous web.

In certain embodiments, the fibrous web may be formed by use of a viscosity modifier to reduce the viscosity of polymer(s) forming the fibers (e.g., aliphatic polyesters, such as PLA) during melt processing. In certain exemplary embodiments, the viscosity modifier is selected from the group consisting of alkyl carboxylates, alkenyl carboxylates, aralkyl carboxylates, alkylethoxylated carboxylates, aralkylethoxylated carboxylates, alkyl lactylates, alkenyl lactylates, and mixtures thereof. The viscosity modifiers are further discussed in U.S. Pat. Pub. No. 2011/0189463.

In certain embodiments, the fibrous web may be formed by the use of a thermoplastic antishrinkage additive. In certain embodiments, the thermoplastic antishrinkage additive includes at least one thermoplastic semicrystalline polymer selected from polyethylene, linear low density polyethylene, polypropylene, polyoxymethylene, poly(vinylidine fluoride), poly(methyl pentene), poly(ethylene-chlorotrifluoroethylene), poly(vinyl fluoride), poly(ethylene oxide), poly(ethylene terephthalate), poly(butylene terephthalate), polycaprolactone, nylon-6, nylon-6,6, and combinations thereof.

In certain embodiments, a thermoplastic antishrinkage additive is present in a total amount of greater than 0 wt-% and no more than 15 wt-%, based on the total weight of the fibrous web. While not intending to be bound by theory, it is believed that particulates (e.g., discrete particulates having an average diameter of less than 250 nm) of antishrinkage additives (e.g., polypropylene) may thereby be evenly distributed throughout the fiber (e.g., the core of the fiber); the antishrinkage additive is believed to act as a selectively miscible additive. While not bound by theory, it is believed that at low concentration (weight percents) of the web, antishrinkage additive mixes with the synthetic thermoplastic polymer and physically inhibits chain movement, thereby suppressing cold crystallization, and macroscopic shrinkage is not observed. If the weight percent of the antishrinkage additive is increased further beyond 10 wt-%, the antishrinkage additive and synthetic thermoplastic polymer phase separate, and rearrangement of the synthetic thermoplastic polymer is not affected. This is further discussed, for example, in U.S. Pat. No. 9,194,065.

In certain embodiments, the fibrous web may include an antimicrobial agent. In this context, the term “antimicrobial agent” means an antiseptic that generally is a small molecule having a molecular weight less than about 1000 Daltons, and often less than 500, daltons capable of killing at least one species of bacteria, fungi, and/or virus or having antimicrobial activity. Preferred antimicrobial agents are lipophilic preferably having a solubility in water of no greater than 1.0 gram per 100 grams (1.0 g/100 g) deionized water. For prolonged use applications, preferred antimicrobial agents (e.g., antimicrobial lipids) have a solubility in water of no greater than 0.5 g/100 g deionized water, more preferably, no greater than 0.25 g/100 g deionized water, and even more preferably, no greater than 0.10 g/100 g deionized water. Solubilities are described using radio-labeled compounds as described under “Conventional Solubility Estimations” in Solubility of Long-Chain Fatty Acids in Phosphate Buffer at pH 7.4, Henrik Vorum et. al., in Biochimica et. Biophysica Acta., 1126, 135-142(1992). Preferred antimicrobial agents have a solubility in deionized water of at least 100 micrograms (m) per 100 grams deionized water, more preferably, at least 500 μg/100 g deionized water, and even more preferably, at least 1000 μg/100 g deionized water.

Exemplary antimicrobial agents include cationic antimicrobial amine compounds; (C7-C22)saturated fatty acid esters of a polyhydric alcohol, (C8-C22) unsaturated fatty acid esters of a polyhydric alcohol, (C7-C22)saturated fatty ethers of a polyhydric alcohol, (C8-C22)unsaturated fatty ethers of a polyhydric alcohol, (C2-C8)hydroxy acid esters of (C7-C22) alcohols, alkoxylated derivatives thereof, and combinations thereof, wherein the alkoxylated derivatives have less than 5 moles of alkoxide group per mole of polyhydric alcohol; with the proviso that for polyhydric alcohols other than sucrose, the esters comprise monoesters and the ethers comprise monoethers, and for sucrose the esters comprise monoesters, diesters, or combinations thereof, and the ethers comprise monoethers, diethers, or mixtures thereof. In certain embodiments, an antimicrobial agent may be present in a total amount of greater than 0 wt-%, or greater than 1 wt-%, based on the weight of the fibrous web.

A fibrous web may also include an antimicrobial enhancer (i.e., an antimicrobial agent enhancer). The enhancer provides for enhanced antimicrobial activity of the antimicrobial agent. Exemplary enhancers may be selected from the group consisting of alpha-hydroxy acids, beta-hydroxy acids, chelating agents, (C2-C6) saturated or unsaturated alkyl carboxylic acids, (C6-C16) aryl carboxylic acids, (C6-C16) aralkyl carboxylic acids, (C6-C12) alkaryl carboxylic acids, phenolic compounds, (C1-C10) alkyl alcohols, ether glycols, oligomers that degrade to release one of the aforesaid enhancers, and mixtures thereof. In certain embodiments, an enhancer may be present in an amount greater than 0.1 wt-%, based on the weight of the fibrous web.

Examples of antimicrobial agent and enhancers are described, for example, in U.S. Pat. No. 9,555,167.

### Thermoplastic Aliphatic Polyester in the Barrier Film

Barrier films of the multilayer articles of the present disclosure may include one or more layers. Each layer may include one or more thermoplastic aliphatic polyester and one or more optional additives. The various layers may include the same thermoplastic aliphatic polyester with different additives, or the same thermoplastic aliphatic polyesters of different molecular weights, or different thermoplastic aliphatic polyesters.

In certain embodiments, the barrier film described herein includes a thermoplastic aliphatic polyester. Examples of thermoplastic aliphatic polyesters for use in the barrier film include a poly(lactic acid), a poly(glycolic acid), a poly(lactic-co-glycolic acid), a polybutylene succinate, a polyhydroxybutyrate, a polyhydroxyvalerate, and combinations thereof.

In certain embodiments, the barrier film described herein includes poly(lactic acid) (“PLA”) polymer. Lactic acid is a renewable material obtained by the bacterial fermentation of corn starch or cane sugar, and thus is considered a natural or in other words “biomass” material. Lactic acid has two optical isomers: L-lactic acid (also known as (S)-lactic acid) and D-lactic acid (also known as (R)-lactic acid), depicted as follows:

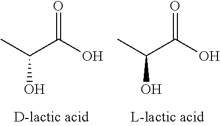

Polyesterification of lactic acid affords poly(lactic acid) polymer.

More typically, lactic acid is typically converted to the cyclic lactide monomer, and the lactide undergoes ring opening polymerization, such as depicted as follows:

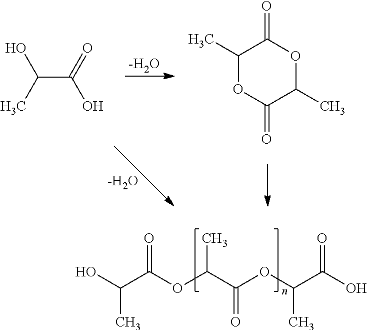

The resulting polymer material is typically referred to as polylactide polymer.

The degree of crystallinity is largely controlled by the ratio of D and/or meso-lactide to L cyclic lactide monomer used. Likewise, for polymers prepared by direct polyesterification of lactic acid, the degree of crystallinity is largely controlled by the ratio of polymerized units derived from D-lactic acid to polymerized units derived from L-lactic acid.

The barrier film described herein generally includes a semicrystalline PLA polymer alone or in combination with an amorphous PLA polymer. Both the semicrystalline and amorphous PLA polymers generally include high concentrations of polymerized units derived from L-lactic acid (e.g., L-lactide) with low concentrations of polymerized units derived from D-lactic acid (e.g., D-lactide).

The semicrystalline PLA polymer typically includes at least 90 wt-%, at least 91 wt-%, at least 92 wt-%, at least 93 wt-%, at least 94 wt-%, at least 95 wt-%, at least 96 wt-%, at least 97 wt-%, or at least 98 wt-% of polymerized units derived from a single isomer. In certain embodiments, the single isomer is L-lactic acid. In some embodiments, the single isomer is D-lactic acid.

The semicrystalline PLA polymer typically includes at least 90 wt-%, at least 91 wt-%, at least 92 wt-%, at least 93 wt-%, at least 94 wt-%, at least 95 wt-%, at least 96 wt-%, at least 97 wt-%, or at least 98 wt-% of polymerized units derived from L-lactic acid (e.g., L-lactide) and no greater than 10 wt-%, no greater than 9 wt-%, no greater than 8 wt-%, no greater than 7 wt-%, no greater than 6 wt-%, or no greater than 5 wt-% of polymerized units derived from D-lactic acid (e.g., D-lactide and/or meso-lactide). In yet other embodiments, the semicrystalline PLA polymer includes at least 96 wt-% of polymerized units derived from L-lactic acid (e.g., L-lactide) and less than 4 wt-%, less than 3 wt-%, or less than 2 wt-% of polymerized units derived from D-lactic acid (e.g., D-lactide and/or meso-lactide).

Alternatively, the semicrystalline PLA polymer typically includes at least 90 wt-%, at least 91 wt-%, at least 92 wt-%, at least 93 wt-%, at least 94 wt-%, at least 95 wt-%, at least 96 wt-%, at least 97 wt-%, or at least 98 wt-% of polymerized units derived from D-lactic acid (e.g., D-lactide) and no greater than 10 wt-%, no greater than 9 wt-%, no greater than 8 wt-%, no greater than 7 wt-%, no greater than 6 wt-%, or no greater than 5 wt-% of polymerized units derived from L-lactic acid (e.g., L-lactide and/or meso-lactide). In yet other embodiments, the semicrystalline PLA polymer includes at least 96 wt-% of polymerized units derived from D-lactic acid (e.g., D-lactide) and less than 4 wt-%, less than 3 wt-%, or less than 2 wt-% of polymerized units derived from L-lactic acid (e.g., L-lactide and/or meso-lactide).

In yet other embodiments, the semicrystalline PLA polymer includes a mixture of two polylactic acid polymers wherein the first polymer is derived from at least 96 wt-% (and preferably at least 97% and more preferably at least 98%) of polymerized units derived from L-lactic acid and the second polymer is derived from at least 96% (and preferably at least 97% and more preferably at least 98%) D-lactide. In one embodiment, PLA polymers can crystallize to form a stereocomplex (Macromolecules, 1987, 20 (4), pp 904-906). The PLA stereocomplex is formed when PLLA (a PLA homopolymer polymerized from mostly L-lactic acid or L-lactide units) is blended with PDLA (a PLA homopolymer polymerized from mostly D-lactic acid or D-lactide units). The stereocomplex crystal of PLA is of interest because the melting temperature of this crystal ranges from 210-250° C. The higher melting temperature stereocomplex PLA crystals increase the thermal stability of the PLA-based material. The PLA stereocomplex crystal also is known to effectively nucleate PLA homopolymer crystallization (Polymer, Volume 47, Issue 15, 12 Jul. 2006, Page 5430). This nucleation effect increases the overall percent crystallinity of the PLA-based material, thus increasing the material's thermal stability.

The barrier film may include an even lower concentration of polymerized units derived from D-lactic acid (e.g., D-lactide and/or meso-lactide) depending on the concentration of semicrystalline PLA polymer in the barrier film. For example, if the barrier film and/or fibrous web includes 15 wt-% of a semicrystalline PLA having 2 wt-% D-lactide and/or meso-lactide, the barrier film would include 0.3 wt-% D-lactide and/or meso-lactide. The barrier film and/or fibrous web may include no greater than 9 wt-%, no greater than 8 wt-%, no greater than 7 wt-%, no greater than 6 wt-%, no greater than 5 wt-%, no greater than 4 wt-%, no greater than 3 wt-%, no greater than 2 wt-%, no greater than 1.5 wt-%, no greater than 1.0 wt-%, no greater than 0.5 wt-%, no greater than 0.4 wt-%, no greater than 0.3 wt-%, no greater than 0.2 wt-%, or no greater than 0.1 wt-% polymerized units derived from D-lactic acid (e.g., D-lactide and/or meso-lactide). Suitable examples of semicrystalline PLA include that available from NatureWorks, LLC (Minnetonka, Minn.) under the trade designation INGEO 4042D and 4032D. These polymers have been described in the literature as having a weight average molecular weight (Mw) of 200,000 grams per mole (g/mol), a number average molecular weight (Mn) of 100,000 g/mol, and a polydispersity of 2.0.

The barrier film may further include an amorphous PLA polymer blended with the semicrystalline PLA. The amorphous PLA typically includes no more than 90 wt-% of polymerized units derived from L-lactic acid and greater than 10 wt-% of polymerized units derived from D lactic acid (e.g., D-lactide and/or meso-lactide). In certain embodiments, the amorphous PLA includes at least 80 wt-% of polymerized units derived from L-lactic acid (e.g., L-lactide). In certain embodiments, the amorphous PLA includes no greater than 20 wt-%. of polymerized units derived from D-lactic acid (e.g., D-lactide and/or meso-lactide). A suitable amorphous PLA includes that available from NatureWorks under the trade designation INGEO 4060D. This polymer has been described in the literature as having a molecular weight Mw of 180,000 g/mol.

For the barrier film, suitable PLA polymers are preferably “film grade” polymers, having a melt flow rate (as measured according to ASTM D1238) of no greater than 25 grams per minute (g/min), no greater than 20 g/min, no greater than 15 g/min, or no greater than 10 g/min at 210° C. with a mass of 2.16 kilograms (kg). In certain embodiments, the PLA polymer has a melt flow rate of less than 10 g/min or less than 9 g/min at 210° C. The melt flow rate is related to the molecular weight of the PLA polymer.

For the barrier film, suitable PLA polymers typically have an Mw (as determined by Gel Permeation Chromatography with polystyrene standards) of at least 50,000 g/mol, at least 75,000 g/mol, at least 100,000 g/mol, at least 125,000 g/mol, or at least 150,000 g/mol. In certain embodiments, the Mw is no greater than 400,000 g/mol, no greater than 350,000 g/mol, or no greater than 300,000 g/mol.

For the barrier film, the PLA polymers typically have a tensile strength of 25 MPa to 150 MPa; a tensile modulus of 1000 MPa to 7500 MPa; and a tensile elongation of at least 3%, at least 4%, or at least 5%, and ranging up to 15%. In certain embodiments, the tensile strength of the PLA polymer is at least 30 MPa, at least 40 MPa, or at least 50 MPa. In certain embodiments, the tensile strength of the PLA polymer is no greater than 125 MPa, no greater than 100 MPa, or no greater than 75 MPa. In certain embodiments, the tensile modulus of the PLA polymer is at least 1500 MPa, at least 2000 MPa, or at least 2500 MPa. In certain embodiments, the tensile modulus of the PLA polymer is no greater than 7000 MPa, no greater than 6500 MPa, no greater than 6000 MPa, no greater than 5500 MPa, no greater than 5000 MPa, or no greater than 4000 MPa. Such tensile strength and tensile elongation properties can be determined by ASTM D882 and are typically reported by the manufacturer or supplier of such PLA polymers.

Suitable PLA polymers for the barrier film generally have a glass transition temperature (Tg) ranging from 50° C. to 65° C. (as can be determined by Differential Scanning calorimetry (DSC)).

Suitable semicrystalline PLA polymers for the barrier film typically have a melting point ranging from 140° C. to 175° C., and even as high as 180° C., 185° C., or 190° C. The PLA polymer, typically including a semicrystalline PLA alone or in combination with an amorphous PLA polymer can be melt-processed at a temperature in a range of 180° C. to 230° C., such as temperatures of 180° C., 190° C., 200° C., 210° C., 220° C., or 230° C.

In certain embodiments, barrier films of the multilayer articles of the present disclosure may include all semicrystalline polymers, all amorphous polymers or combinations thereof (e.g., alternating layers of semicrystalline polymer-containing layers with amorphous polymer-containing layers). For example, in a multilayer barrier film, one or more layers may include a semicrystalline polymer and one or more layers may include an amorphous polymer. Such multicomponent/multilayer barrier films are advantageous in that they can provide different properties to different portions of barrier films.

### Polyvinyl Alkanoate Polymer in the Barrier Film

In addition to the thermoplastic aliphatic polyester, the barrier film further includes a polyvinyl alkanoate polymer. Suitable polyvinyl alkanoate polymers have a Tg of at least −80° C., at least −70° C., at least −60° C., at least −50° C., at least −40° C., at least −30° C., at least −20° C., at least −10° C., or at least 0° C. The Tg of the polyvinyl alkanoate polymer is typically no greater than 70° C., no greater than 60° C., no greater than 50° C., or no greater than 45° C. These include C2 (polyvinyl acetate) to C12 (polyvinyl laurate). Particularly preferred are polyvinyl acetate, polyvinyl butyrate, and polyvinyl laurate. Copolymers such as polyvinyl acetate laurate also are included. Most preferred is polyvinyl acetate.

The polyvinyl alkanoate polymer typically has an Mn or Mw (as determined by Size Exclusion Chromatography with polystyrene standards) of at least 50,000 g/mol, at least 75,000 g/mol, at least 100,000 g/mol, at least 125,000 g/mol, at least 150,000 g/mol, at least 175,000 g/mol, at least 200,000 g/mol, at least 225,000 g/mol, or at least 250,000 g/mol. In certain embodiments, the Mw is no greater than (i.e., up to) 1,000,000 g/mol, no greater than 750,000 g/mol, no greater than 500,000 g/mol, no greater than 450,000 g/mol, no greater than 400,000 g/mol, no greater than 350,000 g/mol, or no greater than 300,000 g/mol. In certain embodiments, the molecular weight of the polyvinyl alkanoate polymer is greater than the molecular weight of the PLA polymer(s) of the barrier film.

The polyvinyl alkanoate polymer may be characterized as having a viscosity in a 10 wt-% ethyl acetate solution at 20° C. of 10 mPa*s to 100 mPa*s (millipascal-sec) (according to ASTM D445-06).

The polyvinyl alkanoate polymer is typically a homopolymer; however, the polymer may include a relatively low concentration of repeat units derived from other comonomers, provided that the Tg of the polyvinyl alkanoate polymer is within a range of −80° C. to 70° C. Other comonomers include, for example, acrylic monomers such as acrylic acid and methyl acrylate; and vinyl monomers such as vinyl chloride, methyl vinyl ether, and vinyl pyrrolidone; and (C₂-C₈)alkylene monomers, such as ethylene. The total concentration of repeat units derived from other comonomers of the polyvinyl alkanoate polymer is typically no greater than 20 wt-%, no greater than 15 wt-%, no greater than 9 wt-%, no greater than 8 wt-%, no greater than 7 wt-%, no greater than 6 wt-%, or no greater than 5 wt-%. In certain embodiments, the concentration of repeat units derived from other comonomers of the polyvinyl alkanoate polymer is typically no greater than 4 wt-%, no greater than 3 wt-%, no greater than 2 wt-%, no greater than 1 wt-%, or no greater than 0.5 wt-%. The polyvinyl alkanoate polymer typically has a low level of hydrolysis. The polymerized units of the polyvinyl alkanoate polymer that are hydrolyzed to units of vinyl alcohol is generally no greater than 10 mol-%, no greater than 9 mol-%, no greater than 8 mol-%, no greater than 7 mol-%, no greater than 6 mol-%, no greater than 5 mol-%, no greater than 4 mol-%, no greater than 3 mol-%, no greater than 2 mol-%, no greater than 1 mol-%, or no greater than 0.5 mol-%, of the polyvinyl alkanoate polymer.

Polyvinyl alkanoate polymers (e.g., polyvinyl acetate polymers) are commercially available from various suppliers including Wacker (Germany) under the trade designations VINNAPAS, and Vinavil (Italy) under the trade designation VINAVIL. Prior to combining with the thermoplastic aliphatic polyester (e.g., PLA), such polyvinyl alkanoate polymers (e.g., polyvinyl acetate polymers) are often in a solid powder (e.g., white powder) or colorless bead form. In certain embodiments, the polyvinyl alkanoate polymer (e.g., polyvinyl acetate polymer) is not water redispersible.

A single polyvinyl alkanoate polymer may be utilized or a combinations of two or more polyvinyl alkanoate polymers may be utilized in making the barrier films of the multilayer articles of the present disclosure.

The total amount of polyvinyl alkanoate polymer present in the barrier film described herein is typically at least 10 wt-%, at least 15 wt-%, or at least 20 wt-%, based on the total weight of the barrier film (e.g., thermoplastic aliphatic polyester (e.g., PLA), polyvinyl alkanoate polymer (e.g., polyvinyl acetate polymer), and plasticizer). The total amount of polyvinyl alkanoate polymer present in the barrier film described herein is typically no greater than (i.e., up to) 50 wt-%, no greater than 45 wt-%, or no greater than 40 wt-%, based on the total weight of the barrier film.

### Plasticizer in the Barrier Film

The barrier film also includes a plasticizer. The plasticizer is not a lactide (i.e., it is a non-lactide plasticizer). The plasticizer has an acid number of no greater than 10 (in certain embodiments, no greater than 7, and in certain embodiments no greater than 5). The plasticizer has a weight average molecular weight of no greater than 5,000 g/mol. As used herein a “plasticizer” is a compound that when melt blended with polylactic acid results in a decrease in the Tg when measured by differential scanning calorimetry (DSC). The plasticizers generally decrease the tensile modulus and increase tensile elongation.

The total amount of plasticizer in the barrier film is typically at least 5 wt-%, at least 10 wt-%, or at least 15 wt-%, based on total weight of the barrier film (e.g., thermoplastic aliphatic polyester (e.g., PLA), polyvinyl alkanoate polymer (e.g., polyvinyl acetate polymer), and plasticizer). The total amount of plasticizer in the barrier film is typically up to 35 wt-%, up to 30 wt-%, or up to 25 wt-%, based on total weight of the barrier film. Various combinations of plasticizers may be utilized in barrier films of the multilayer articles of the present disclosure.

Various plasticizers that are capable of plasticizing thermoplastic aliphatic polyester (e.g., PLA) have been described in the art. Suitable plasticizers are generally a liquid at 25° C. and typically have a weight average molecular weight of at least 200 g/mol. In certain embodiments, the molecular weight of the plasticizer is no greater than 5,000 g/mol. In other embodiments, the molecular weight of the plasticizer is no greater than 4,000 g/mol, no greater than 3,000 g/mol, no greater than 2,000 g/mol, or no greater than 1,000 g/mol.

In certain embodiments, suitable plasticizers generally lack aromatic groups and halogen atoms and are often biodegradable. In certain embodiments, suitable plasticizers do not include carboxylic acid groups or sulfonic acid groups.

In certain embodiments, suitable plasticizers include one or more ester or ether groups. Multi-functional esters and/or ethers may be used. Examples of suitable plasticizers include alkyl phosphate esters, dialkylether diesters, tricarboxylic esters, epoxidized oils and esters, polyesters, polyglycol diesters, alkyl alkylether diesters, aliphatic diesters, alkylether monoesters, citrate esters, dicarboxylic esters, vegetable oils, and esters of glycerine.

In certain embodiments, suitable plasticizers include linear or branched alkyl terminal groups having a carbon chain length of C2 to C10.

In one embodiment, the plasticizer is a bio-based citrate-based plasticizer represented by the following Formula (I):

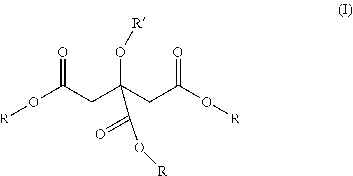

wherein:
R may be the same or different and wherein at least one R is a linear or branched alkyl group; and
R′ is an H, an alkyl group, or an acyl group.

In certain embodiments, each R is independently a linear or branched alkyl group having a carbon chain length of C1 to C10. In certain embodiments, R is a (C2 to C8) or a (C2 to C4) linear alkyl group. In certain embodiments, R′ is acetyl. In certain embodiments, at least one R is a branched alkyl groups having a carbon chain length of C5 or greater. In certain embodiments, the branched alkyl group has a carbon chain length no greater than 8.

In certain embodiments, the plasticizers include (C1 to C4) citrate esters.

Representative citrate-based plasticizers include, for example, triethyl citrate, acetyl triethyl citrate, tributyl citrate, acetyl tributyl citrate, trihexyl citrate, acetyl trihexyl citrate, trioctyl citrate, acetyl trioctyl citrate, butyryl trihexyl citrate, acetyl tris-3-methylbutyl citrate, acetyl tris-2-methylbutyl citrate, acetyl tris-2-ethylhexyl citrate, and acetyl tris-2-octyl citrate.

In certain embodiments, the plasticizers include a polyethylene glycol backbone and ester alkyl terminal groups. The molecular weight of the polyethylene glycol segment is typically at least 100 g/mol, at least 150 g/mol, or at least 200 g/mol, and typically no greater than 1,000 g/mol. In certain embodiments, the polyethylene glycol segment has a molecular weight of no greater than 900 g/mol, no greater than 800 g/mol, no greater than 700 g/mol, or no greater than 600 g/mol.

Examples of plasticizers include polyethylene glycol (400) di-ethylhexonate availalble from Hallstar, Chicago, Ill. under the trade designation “TegMeR 809” and tetraethylene glycol di-ethylhexonate available from Hallstar, Chicago, Ill. under the trade designation “TegMeR 804.”

In certain embodiments, the plasticizer typically has little or no hydroxyl groups. In certain embodiments, the weight percent of hydroxyl groups relative to the total weight of the plasticizer is no greater than 10 wt-%, no greater than 9 wt-%, no greater than 8 wt-%, no greater than 7 wt-%, no greater than 6 wt-%, no greater than 5 wt-%, no greater than 4 wt-%, no greater than 3 wt-%, no greater than 2 wt-%, or no greater than 1 wt-%. In certain embodiments, the plasticizer contains no hydroxyl groups. Thus, in this embodiment, the plasticizer is not glycerol or water.

### Other Optional Additives in the Barrier Film

To facilitate the rate of crystallization, a nucleating agent may also be present in the barrier film. The nucleating agent may include an organic compound, an inorganic compound, or combination thereof.

Suitable nucleating agent(s) include, for example, inorganic minerals, pigments, organic compounds, salts of organic acids and imides, finely divided crystalline polymers with a melting point above the processing temperature of the thermoplastic aliphatic polyester (e.g., PLA), and combinations of two or more of the foregoing. Suitable nucleating agents typically have an average particle size of at least 25 nanometers, and generally at least 0.05 micron or at least 0.1 micron. Combinations of two or more different nucleating agents may also be used.

In certain embodiments, the nucleating agent includes a pigment.

Examples of useful nucleating agents include, for example, talc (hydrated magnesium silicate—H₂Mg₃(SiO₃)₄ or Mg₃Si4O₁₀(OH)₂), silica (SiO₂), titania (TiO₂), alumina (Al₂O₃), zinc oxide, sodium salt of saccharin, calcium silicate, sodium benzoate, calcium titanate, aromatic sulfonate derivative, boron nitride, copper phthalocyanine, phthalocyanine, sodium salt of saccharin, isotactic polypropylene, polybutylene terephthalate, phosphates and phosphonates including aromatic phosphonates, and the like. In certain embodiments, the nucleating agent includes copper phthalocyanine and/or an aromatic phosphonate.

When an organic nucleating agent is present, one or more are typically present at a concentration of at least 0.01 wt-%, at least 0.02 wt-%, at least 0.03 wt-%, at least 0.04 wt-%, at least 0.05 wt-%, at least 0.1 wt-%, at least 0.15 wt-%, or at least 0.2 wt-%, based on the total weight of the barrier film. When one or more organic nucleating agents are present, it is typically present at a concentration of up to 10 wt-%, up to 5 wt-%, up to 4 wt-%, up to 3 wt-%, up to 2 wt-%, or up to 1 wt-%, based on the total weight of the barrier film.

When the nucleating agent is an inorganic oxide filler, such as silica, alumina, zinc oxide, and talc, the concentration can be higher.

In certain embodiments, the nucleating agent may be characterized as a salt of an organic acid. In certain embodiments, the nucleating agent may be characterized as a salt of an aromatic organic acid. In certain embodiments, the nucleating agent may be characterized as a salt of a phosphorous-containing aromatic organic acid, such as zinc phenylphosphonate, magnesium phenylphosphonate, disodium 4-tert-butylphenyl phosponate, and sodium diphenylphosphinates.

One favored nucleating agent is zinc phenylphosphonate having the following chemical formula:

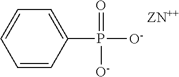

available from Nissan Chemical Industries, Ltd. under the trade designation ECOPROMOTE.

In certain embodiments, inorganic fillers may be used to prevent blocking or sticking of layers or rolls of the film during storage and transport. Inorganic fillers include clays and minerals, either surface modified or not. Examples include talc, diatomaceous earth, silica, mica, kaolin, titanium dioxide, perlite, and wollastonite.

In some embodiments, organic antiblock additives are used in the barrier film to prevent the blocking or sticking of barrier film to barrier film and barrier film to fibrous web during storage and transport. Organic antiblocks may be migratory in nature and may crystallize on the film surface, forming interfering layers between the adjacent layers. Examples include, ethylene bis-stearamide, ethylene bis-oleamide, stearyl erucamide, stearamide, erucamide, oleamide, oleyl palmitamide, behenamide, glycerol monostearate, zinc stearate.

The barrier film of the present disclosure may optionally contain one or more conventional additives. Additives include, for example, antioxidants, stabilizers, ultraviolet absorbers, lubricants, processing aids, antistatic agents, perfumes, impact resistance aids, fillers, matting agents, flame retardants (e.g., zinc borate), pigments, dyes, fillers, slip agents, antiblock agents, microwave susceptors, thermally conductive particles, electrically conductive particles, and/or other materials to increase the flexibility, handleability, visibility, or other useful property of the film, as long as they do not adversely affect the desired properties of the adhesive composition.

### Preparation of the Barrier Film and Multilayer Articles

In certain embodiments, the barrier film of the present disclosure is a film having a thickness of at least 10 microns, at least 15 microns, at least 20 microns, or at least 25 microns (1 mil). In certain embodiments, the barrier film of the present disclosure is a film having a thickness of up to 250 microns (10 mils), 100 microns, up to 150 microns, or up to 50 microns. The barrier film may be in the form of a monolayer or multilayer film.

In preparing a barrier film as described herein, the thermoplastic aliphatic polyester, polyvinyl alkanoate polymer, plasticizer, and various additives such as nucleating agent, antiblock agent, pigment, etc. are heated to a temperature of, for example, 180° C. to 250° C. and thoroughly mixed using any suitable means known by those of ordinary skill in the art. For example, the barrier film may be mixed by use of a (e.g., Brabender) mixer, extruder, kneader, or the like.

Following mixing, the barrier film may be formed (e.g., cast) into a film using known film-forming techniques, taking in to consideration the scale of the process and available equipment. In certain embodiments, the barrier film may be extruded through a die directly onto the fibrous web. In certain embodiments, the barrier film may be extruded through a die onto a casting roll maintained at a suitable cooling temperature to form a continuous length of film. Then, the barrier film may be heat laminated with the fibrous web.

A single layer or multilayer barrier film structure can be applied to the nonwoven, absorbent layer by laminating a preformed film using a heated calender and pressure. Alternatively and preferably the barrier film is applied by melt extrusion through a single layer extrusion die or if the film is multilayer using, for example, a CLOEREN feedblock, with a multilayer configured selector plug, and a drop die, resulting in a multilayer construction. The molten extruded film curtain is applied and sent through a nip roller. Preferably the melt temperature and nip pressure are controlled to apply the barrier film to the nonwoven surface and not force the polymer into the nonwoven. Forcing the barrier film into the nonwoven can result in a stiffer fabric and/or microperforations.

### Exemplary Embodiments

Embodiment 1 is a multilayer article comprising: a fibrous web comprising fibers comprising natural fibers, synthetic fibers, or combinations thereof; wherein the synthetic fibers comprise a synthetic thermoplastic polymer selected from an aliphatic polyester, an aromatic polyester, a polyamide, and combinations thereof; and a barrier film (which may include one or more layers) directly bonded fibrous web; wherein the barrier film comprises: a thermoplastic aliphatic polyester; a polyvinyl alkanoate polymer having a Tg of at least −80° C.; and a non-lactide plasticizer having an acid number of no greater than 10 (in certain embodiments, no greater than 7, and in certain embodiments no greater than 5) and having a weight average molecular weight of no greater than 5000 g/mol.

Embodiment 2 is the multilayer article of embodiment 1, wherein the non-lactide plasticizer is free of carboxylic acid groups or sulfonic acid groups.

Embodiment 3 is the multilayer article of embodiment 1 or 2, wherein the fibrous web is instantaneously absorbent to water.

Embodiment 4 is the multilayer article of any of embodiments 1 through 3, wherein the fibrous web comprises a woven web or a nonwoven web.

Embodiment 5 is the multilayer article of embodiment 4, wherein the fibrous web comprises a nonwoven web selected from a melt-blown web, a spun-bond web, a spun-laced web, a wet-laid web, a dry-laid web, and a combination thereof.

Embodiment 6 is the multilayer article of any of embodiments 1 through 5, wherein the fibrous web comprises natural fibers.

Embodiment 7 is the multilayer article of embodiment 6, wherein the natural fibers are selected from bamboo fibers, soy bean fibers, agave fibers, coco fibers, rayon fibers, cellulosic fibers, wood pulp fibers, cotton fibers, hemp fibers, ramie fibers, rattan fibers, vine fibers, kenaf fibers, flax fibers, jute fibers, silk fibers, wool fibers, other animal derived fibers, and derivatives and combinations thereof.

Embodiment 8 is the multilayer article of any of embodiments 1 through 5, wherein the fibrous web comprises synthetic fibers comprising a synthetic thermoplastic polymer.

Embodiment 9 is the multilayer article of embodiment 8, wherein the synthetic thermoplastic polymer comprises an aliphatic polyester.

Embodiment 10 is the multilayer article of embodiment 9, wherein the aliphatic polyester of the fibrous web is selected from a poly(lactic acid), a poly(glycolic acid), a poly(lactic-co-glycolic acid), a polybutylene succinate, a polyhydroxybutyrate, a polyhydroxyvalerate, and combinations thereof.

Embodiment 11 is the multilayer article of embodiment 10, wherein the aliphatic polyester of the fibrous web is selected from a poly(lactic acid).

Embodiment 12 is the multilayer article of any of embodiments 9 through 11, wherein the aliphatic polyester of the fibrous web is semicrystalline.

Embodiment 13 is the multilayer article of embodiment 12, wherein the semicrystalline aliphatic polyester comprises at least 90 wt-%, or at least 95 wt-%, or at least 98 wt-%, of polymerized units derived from a single isomer.

Embodiment 14 is the multilayer article of embodiment 13, wherein the single isomer is L-lactic acid.

Embodiment 15 is the multilayer article of embodiment 8, wherein thermoplastic polymer is an aromatic polyester.

Embodiment 16 is the multilayer article of embodiment 15, wherein the aromatic polyester is selected from a poly(ethylene) terephthalate (PET), a poly(ethylene) terephthalate glycol (PETG), a poly(butylene) terephthalate (PBT), a poly(trimethyl) terephthalate (PTT), and combinations thereof.

Embodiment 17 is the multilayer article of embodiment 8, wherein thermoplastic polymer is a polyamide.

Embodiment 18 is the multilayer article of embodiment 17, wherein the polyamide is selected from the group of nylon-6, nylon-7, nylon-8, nylon-9, nylon-10, nylon-11, nylon-12, nylon-13, nylon-14, nylon-15, nylon-16, nylon-17, nylon-18, nylon-6,6, nylon-6,8, nylon-6,10, nylon-6,12, nylon-6,14, nylon-8,8, nylon-8,10, nylon-8,12, nylon-8,14, nylon-10,10, nylon-10,12, nylon-8,12, nylon-10,14, nylon-12,12, nylon-12,14, nylon-14,16, and combinations thereof.

Embodiment 19 is the multilayer article of embodiment 18, wherein the polyamide is selected from the group of nylon-6, nylon-6,6, and combinations thereof.

Embodiment 20 is the multilayer article of any of embodiments 1 through 19, wherein the fibrous web further comprises a surfactant.

Embodiment 21 is the multilayer article of embodiment 20, wherein the surfactant is incorporated in the synthetic polymer of the fibers.

Embodiment 22 is the multilayer article of embodiment 20, wherein the fibers comprise a core and a sheath, wherein the core may comprises the polymer (e.g., a semicrystalline polymer), and the sheath may comprises the polymer (e.g., an amorphous polymer) and (optionally) the surfactant.

Embodiment 23 is the multilayer article of embodiment 20, wherein the surfactant is disposed on the fibers.

Embodiment 24 is the multilayer article of embodiment 20, wherein the surfactant is disposed on the fibrous web.

Embodiment 25 is the multilayer article of any of embodiments 20 through 25, wherein the surfactant is selected from a nonionic surfactant, an anionic surfactant, a cationic surfactant, a zwitterionic surfactant, and combinations thereof.

Embodiment 26 is the multilayer article of embodiment 25, wherein the fibrous web comprises a nonionic surfactant.

Embodiment 27 is the multilayer article of embodiment 26, wherein the fibrous web comprises a combination of a nonionic surfactant with an anionic surfactant or a zwitterionic surfactant.

Embodiment 28 is the multilayer article of any of embodiments 25 through 27, wherein the anionic surfactant is selected from alkyl, alkenyl, alkaryl, arakyl, or alkylalkoxylated carboxylates, sulfonates, sulfates, phosphonates, phosphates, and combinations thereof.

Embodiment 29 is the multilayer article of embodiment 28, wherein the anionic surfactant is selected from a (C8-C22)alkyl sulfate salt, a di(C8-C13 alkyl)sulfosuccinate salt, a (C8-C22)alkyl sarconsinate, a (C8-C22)alkyltaurate, a (C8-C22)alkyl lactylate, and combinations thereof.

Embodiment 30 is the multilayer article of any of embodiments 25 through 29, wherein the nonionic surfactant is a liquid at room temperature.

Embodiment 31 is the multilayer article of any of embodiments 25 through 30, wherein the nonionic surfactant comprises a branched alkyl chain, an unsaturated alkyl chain, a polyalkoxylate group, or a combination thereof.

Embodiment 32 is the multilayer article of embodiment 31, wherein the nonionic surfactant is a polyalkoxylated nonionic surfactant.

Embodiment 33 is the multilayer article of embodiment 32, wherein the polyalkoxylated nonionic surfactant is selected from an alkyl ether polyalkoxylate, an ethoxylated secondary alcohol, an alkyl ester polyalkoxylate, an alkyl amide polyalkoxylate, an alkoxylated sorbitan fatty ester, an alkoxylated ester of a polyhydric alcohol, an alkoxylated ether of a polyhydric alcohol, an alkyl polyglucoside, an alkyl polyglycerin ester, and combinations thereof.

Embodiment 34 is the multilayer article of any of embodiments 20 through 33, wherein the surfactant is present in a total amount of at least 0.25 wt-%, based on the total weight of the fibrous web.

Embodiment 35 is the multilayer article of any of embodiments 20 through 34, wherein the surfactant is present in a total amount of no greater than 15 wt-%, based on the total weight of the fibrous web.

Embodiment 36 is the multilayer article of any of embodiments 20 through 35, wherein the fibrous web further comprises a nonvolatile surfactant carrier.

Embodiment 37 is the multilayer article of embodiment 36, wherein the nonvolatile surfactant carrier is a liquid at room temperature.

Embodiment 38 is the multilayer article of embodiment 36 or 37, wherein the nonvolatile surfactant carrier comprises at least one of a polyalkylene oxide, a thermally stable polyhydric alcohol, a low molecular weight ester of a polyhydric alcohol, and combinations thereof.

Embodiment 39 is the multilayer article of embodiment 38, wherein the nonvolatile surfactant carrier is selected from polyethylene glycol, polypropylene glycol, random and block copolymers of ethylene oxide and propylene oxide, propylene glycol, glycerin, polyglycerin, triacetin, glyceryl caprylate/caprate, acetyltributylcitrate, and combinations thereof.

Embodiment 40 is the multilayer article of any of embodiments 36 through 39, wherein the nonvolatile surfactant carrier is present in a total amount of at least 0.1 wt-%, based on the total weight of the fibrous web.

Embodiment 41 is the multilayer article of any of embodiments 36 through 40, wherein the nonvolatile surfactant carrier is present in a total amount of no greater than 10 wt-%, based on the total weight of the fibrous web.

Embodiment 42 is the multilayer article of any of embodiments 1 through 41, wherein the fibrous web further comprises a thermoplastic antishrinkage additive.

Embodiment 43 is the multilayer article of embodiment 42, wherein the thermoplastic antishrinkage additive comprises at least one thermoplastic semicrystalline polymer selected from polyethylene, linear low density polyethylene, polypropylene, polyoxymethylene, poly(vinylidine fluoride), poly(methyl pentene), poly(ethylene-chlorotrifluoroethylene), poly(vinyl fluoride), poly(ethylene oxide), poly(ethylene terephthalate), poly(butylene terephthalate), polycaprolactone, nylon-6, nylon-6,6, and combinations thereof.

Embodiment 44 is the multilayer article of embodiment 42 or 43, wherein the thermoplastic antishrinkage additive is present in a total amount of greater than 0 wt-% and no more than 15 wt-%, based on the total weight of the fibrous web.

Embodiment 45 is the multilayer article of any of embodiments 1 through 44, wherein the thermoplastic aliphatic polyester of the barrier film is selected from a poly(lactic acid), a poly(glycolic acid), a poly(lactic-co-glycolic acid), a polybutylene succinate, a polyhydroxybutyrate, a polyhydroxyvalerate, and combinations thereof.

Embodiment 46 is the multilayer article of embodiment 45, wherein the thermoplastic aliphatic polyester of the barrier film is selected from a poly(lactic acid).

Embodiment 47 is the multilayer article of embodiment 45 or 46, wherein the thermoplastic aliphatic polyester of the barrier film is semicrystalline.

Embodiment 48 is the multilayer article of embodiment 47, wherein the semicrystalline aliphatic polyester comprises at least 90 wt-%, or at least 95 wt-%, or at least 98 wt-%, of polymerized units derived from a single isomer.

Embodiment 49 is the multilayer article of embodiment 48, wherein the single isomer is L-lactic acid.

Embodiment 50 is the multilayer article of any one of embodiments 46 through 49, wherein the poly(lactic acid) of the barrier film has a melt flow rate of no greater than 25 g/min at 210° C.

Embodiment 51 is the multilayer article of any of embodiments 46 through 50 wherein the poly(lactic acid) of the barrier film has a Tg ranging from 50° C. to 65° C.

Embodiment 52 is the multilayer article of any of embodiments 47 through 51, wherein the barrier film further comprises an amorphous aliphatic polyester.

Embodiment 53 is the multilayer article of any of embodiments 1 through 52, wherein the barrier film may include multiple layers, wherein all the layers include a semicrystalline polymer, all the layers include an amorphous polymer, or combinations thereof (e.g., alternating layers of semicrystalline polymer-containing layers with amorphous polymer-containing layers). Embodiment 54 is the multilayer article of any of embodiments 1 through 53, wherein the polyvinyl alkanoate (e.g., polyvinyl acetate) polymer has a weight average molecular weight of at least 75,000 g/mol.

Embodiment 55 is the multilayer article of any of embodiments 1 through 54, wherein the polyvinyl alkanoate (e.g., polyvinyl acetate) polymer has a weight average molecular weight of up to 750,000 g/mol.

Embodiment 56 is the multilayer article of any of embodiments 1 through 55, wherein the polyvinyl alkanoate (e.g., polyvinyl acetate) polymer has a viscosity ranging from 10 mPa*s to 100 mPa*s when the polyvinyl alkanoate (e.g., polyvinyl acetate) polymer is dissolved in a 10% ethyl acetate solution at 20° C.

Embodiment 57 is the multilayer article of any of embodiments 1 through 56, wherein the polyvinyl alkanoate (e.g., polyvinyl acetate) polymer is present in an amount of at least 10 wt-%, based on the total weight of the barrier film.

Embodiment 58 is the multilayer article of any of embodiments 1 through 57 wherein the polyvinyl alkanoate polymer is present in an amount of up to 50 wt-%, based on the total weight of the barrier film.

Embodiment 59 is the multilayer article of any of embodiments 1 through 58, wherein the plasticizer is present in an amount of at least 5 wt-%, or at least 10 wt-%, or at least 15 wt-%, based on the total weight of the barrier film.

Embodiment 60 is the multilayer article of any of embodiments 1 through 59, wherein the plasticizer is present in an amount of up to 35 wt-%, or up to 30 wt-%, or up to 25 wt-%, based on the total weight of the barrier film.

Embodiment 61 is the multilayer article of any of embodiments 1 through 60, wherein the plasticizer comprises one or more ester or ether groups.

Embodiment 62 is the multilayer article of any of embodiments 1 through 61, wherein the plasticizer is of the formula:

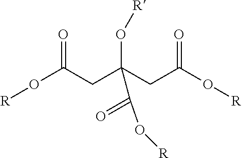

wherein:
R may be the same or different and wherein at least one R is a linear or branched alkyl group; and
R′ is an H, an alkyl group, or an acyl group.

Embodiment 63 is the multilayer article of embodiment 62, wherein the plasticizer comprises (C1-C4) citrate esters.

Embodiment 64 is the multilayer article of any of embodiments 1 through 63, wherein the barrier film further comprises a nucleating agent.

Embodiment 65 is the multilayer article of embodiment 64, wherein the nucleating agent comprises an organic compound, an inorganic compound, or combination thereof.

Embodiment 66 is the multilayer article of embodiment 64, wherein the nucleating agent comprises a pigment.

Embodiment 67 is the multilayer article of embodiment 64, wherein the nucleating agent comprises copper phthalocyanine and/or an aromatic phosphonate.

Embodiment 68 is the multilayer article of any of embodiments 64 through 67, wherein the barrier film comprises a nucleating agent in an amount of at least 0.01 wt-%, based on the total weight of the barrier film.

Embodiment 69 is the multilayer article of any of embodiments 64 through 68, wherein the barrier film comprises a nucleating agent in an amount of up to 10 wt-%, based on the total weight of the barrier film.

Embodiment 70 is the multilayer article of any of embodiments 64 through 69, wherein the nucleating agent is a salt of an organic acid.

Embodiment 71 is the multilayer article of embodiment 70, wherein the nucleating agent is a salt of a phosphorous-containing aromatic organic acid.

Embodiment 72 is the multilayer article of any of embodiments 1 through 71, wherein the barrier film further comprises an antiblock agent.

Embodiment 73 is the multilayer article of embodiment 72, wherein the antiblock agent comprises an organic compound, an inorganic compound, or combination thereof.

Embodiment 74 is the multilayer article of any of embodiments 1 through 73, wherein the barrier film does not exhibit plasticizer migration when aged at 70° C. or 80° C. for 24 hours.

Embodiment 75 is the multilayer article of any of embodiments 1 through 74, which has a stiffness of no greater than 7.0 N, according to ASTM D4032-08.

Embodiment 76 is the multilayer article of any of embodiments 1 through 75, wherein the barrier film is directly bonded to the hydrophilic absorbent layer by thermal bonding.

Embodiment 77 is the multilayer article of any of embodiments 1 through 76, wherein the barrier film has a net melting endotherm for a first heating scan, ΔHₙₘ₁, of greater than 10 J/g.

Embodiment 78 is the multilayer article of any of embodiments 1 through 77, wherein the barrier film has a Tg of less than 30° C., or less than 25° C., or less than 20° C., or less than 15° C., or less than 10° C.

Embodiment 79 is the multilayer article of any of embodiments 1 through 78, wherein the barrier film has a tensile elongation of at least 50%.

Embodiment 80 is the multilayer article of any of embodiments 1 through 79, wherein the barrier film has a tensile elongation of up to 600%.

Embodiment 81 is the multilayer article of any of embodiments 1 through 80, wherein the barrier film has a tensile modulus of at least 50 MPa.

Embodiment 82 is the multilayer article of any of embodiments 1 through 81, wherein the barrier film has a tensile modulus of up to 500 MPa.

Embodiment 83 is the multilayer article of any of embodiments 1 through 82, which is in the form of a surgical drape, a surgical gown, a sterilization wrap, or a patient warming device.

Embodiment 84 is a method of making a multilayer article, the method comprising:

providing a fibrous web comprising fibers comprising natural fibers, synthetic fibers, or combinations thereof; wherein the synthetic fibers comprise a synthetic thermoplastic polymer selected from an aliphatic polyester, an aromatic polyester, a polyamide, and combinations thereof; and

directly bonding a barrier film (which may include one or more layers) to the fibrous web; wherein the barrier film comprises:
a thermoplastic aliphatic polyester; a polyvinyl alkanoate polymer having a Tg of at least −80° C.; and
a non-lactide plasticizer having an acid number of no greater than 10 (in certain embodiments, no greater than 7, and in certain embodiments no greater than 5) and having a weight average molecular weight of no greater than 5000 g/mol.

Embodiment 85 is the method of embodiment 84, wherein directly bonding a barrier layer to the fibrous web comprises thermally bonding the barrier layer to the fibrous web.

Embodiment 86 is the method of embodiment 85, wherein thermally bonding comprises extrusion coating, thermally laminating (e.g., calendering), ultrasonic bonding, or RF welding.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims. Unless otherwise noted, amounts of material are listed by weight, or by weight percent (“wt-%”).

TABLE 1
Materials

| Name/ | | |
|---|---|---|
| Abbreviation | Description/Use | Source |
| PLA #1 | INGEO 4032D - a semicrystalline polylactic acid | NatureWorks, LLC, |
| | (PLA) (2 wt-% D-lactide; weight average molecular | Minnetonka, MN |
| | weight of approximately 200,000 g/mol) | |
| PLA #2 | INGEO 4060D - amorphous polylactic acid (PLA) | NatureWorks, LLC, |
| | (10 wt-% D-lactide; weight average molecular | Minnetonka, MN |
| | weight of approximately 180,000 g/mol) | |
| PLA #3 | SYNTERRA PDLA 1010, a semicrystalline | Synbra Technology, The |
| | polylactic acid (99+ wt-% D-lactic acid), | Netherlands |
| PVAc #1 | VINNAPAS UW 4 FS polyvinyl acetate (Tg = | Wacker, Germany |
| | 42° C.; weight average molecular weight ≈ 280,000 | |
| | g/mol), | |
| PVAc #2 | VINAVIL K70, polyvinyl acetate (Tg = 42° C.; | Vinavil, Italy |
| | weight average molecular weight of approximately | |
| | 400,000 g/mol), | |
| PVAC-L | VINNEX 8880, poly(vinyl acetate-co-vinyl laurate) | Wacker, Germay |
| | (Tg = 21° C.) | |
| CITROFLEX A4 | acetyl tributyl citrate, a plasticizer | Vertellus Performance |
| | | Materials, Bayonne, NJ, |
| | | USA |
| ECOPROMOTE | zinc phenylphosphonate, a nucleation agent | Nissan Chemical |
| | | Industrials (Japan) |
| SUKANO DC | erucamide and silica slip/antiblock additives in | Sukano AG (US). |
| S511 | INGEO PLA4032 masterbatch | |
| SUKANO DC | silica antiblock additive in INGEA PLA4032 | Sukano AG (US) |
| S709 | masterbatch, | |
| SUKANO NA | ethylene bis-stearamide antiblock additive in Ingeo | Sukano AG (US). |
| S516 | PLA4032 masterbatch, | |
| CLARIANT | CaCO3 antiblock additive in Ingeo PLA4032 | Clariant Corporation, |
| CaCO3 | masterbatch | Minneapolis, MN |
| CLARIANT | Diatomaceous Earth (DE) antiblock additive in | Clariant Corporation, |
| Diatomaceous | Ingeo PLA4032 masterbatch | Minneapolis, MN |
| Earth | | |
| CLARIANT | SUPERFLOSS antiblock additive in Ingeo | Clariant Corporation, |
| 4060SF | PLA4060 masterbatch | Minneapolis, MN |
| CLARIANT | Ultratalc 609 antiblock additive in Ingeo PLA4060 | Clariant Corporation, |
| 4060UT | masterbatch | Minneapolis, MN |
| CLARIANT | Ultratalc 609 antiblock additive in Ingeo PLA4032 | Clariant Corporation, |
| 4032UT | masterbatch | Minneapolis, MN |
| PEG3350 | MiraLAX, brand, polyethylene glycol, (molecular | Costco, Sam's Club, |
| | weight = 3350 g/mol) | Woodbury, MN |
| PLAM58162 | blue pigment in Ingeo PLA4032 masterbatch, | Techmer PM (US) |
| PBS | BioPBS, polybutylene succinate, grade FD92PM | Mitsubishi Chemical |
| | | Performance Polymers |

### Test Methods

Hydrohead

Hydrohead (HH) testing was performed according to test method EN20811-1993 at a pressure increase of 60 mbar per minute or 10 mbar per minute with the barrier side up and no other support. Most medical fabrics have a need to be sterile. Select examples were sterilized using ethylene oxide gas (EO) in a commercially available EO sterilizer according standard procedures. These examples were properly aerated at 45-50° C. for the specified time prior to subsequent HH testing. Hydrohead testing was performed on select examples both before and after EO sterilization as indicated below. Examples 1-13 in Table 3 and Table 4 were tested at 60 mbar/minute for hydrohead prior to EO sterilization. Examples 14-39, presented in Table 4 were tested for HH before EO sterilization. Examples 4-13 in Table 4 were also tested for HH after EO sterilization and were tested at 10 mbar/minute.

Ink Migration Test

The film side of a 3 inch by 3 inch sample of the barrier layer was marked with 5 lines from side to side, with a SHARPIE brand felt tip permanent marker. The marker color was black and the tip style was “fine point”. The samples were placed in the closed glass bottles to prevent plasticizer evaporation during aging testing, and aged in the oven at 70-80° C. for 24 hours. After aging at elevated temperature, the samples were removed and observed for indication of plasticizer migration in the following manner. If the ink was observed as “running” or could be easily smeared by a bare finger when wiped across the ink drawn line due to an oily surface, then this indicating an unacceptable amount of plasticizer migration had occurred. Lines that smeared were considered to fail. Samples having a non-oily surface and non-smearing of the ink lines were considered to pass.

Stiffness of Fabric by the Circular Bend Procedure

Samples were tested according to ASTM method ASTM D4032-08(2012) Standard Test Method for Stiffness of Fabric by the Circular Bend Procedure, ASTM International, West Conshohocken, Pa., 2012. Results are reported in units of newtons (N).

Noise Test

The noise level of prepared examples was measured by the following method. Samples were cut to 3 inch×3 inch (7.6 cm×7.6 cm) square. The sample was placed in the flat open hand of the human tester. The hand was closed and opened (flexed) 5 times per sample and the noise level was assigned a subjective value from 0 to 5 by the human tester. As a control standard, a single sheet of uncoated 46 gsm hydrophilic PLA spunbond nonwoven was assigned a noise level of 0.

Blocking Test

The film sides of the barrier layer of two 3 inch by 3 inch samples were placed against each under a weight of about 0.5 kg. The samples were placed in the oven at 65° C. for about one hour. The two sheets were then manually pulled apart to assess the “sticking together” (A.K.A. “blocking”) of the two sheets. The blocking results observed were assigned numerical values according to the following descriptions: 0=no blocking, two sheets did not stick together; 1=slight blocking; 2=some moderate blocking; 3=severe blocking—sheets could not be separated.

Preparation of Nonwoven Web Substrates

Multiple nonwovens were evaluated. A hydrophilic PLA-based nonwoven was made with two layers of spunbond totaling approximately 46 grams per square meter, unless otherwise specified gsm.

Both layers had fiber sheaths containing 1.5% of a blue masterbatch (PPM56090), purchased from Techmer Polymer Modifiers, Clinton, Tenn., and PLA 6202D. One layer of the nonwoven also contained 1.75% by weight Hetoxamide C-4 (PEG-5 Cocamide; Global 7, Incorporated, Franklin, N.J.) and 1.75% by weight JDOSS 50P (50% Docusate Sodium in PEG 400; JLK Industries, Coopersburg, Pa.) to make it hydrophilic. The other layer was not originally produced with surfactant in either fiber component. The fiber core for both layers was contained of 1.5% by weight of a blue masterbatch (PPM56090) pre-compounded into polypropylene and purchased from Techmer Polymer Modifiers, Clinton, Tenn. The fiber cores were primarily composed of PLA 6100D, purchased from NatureWorks, LLC. The layers were thermally bonded together using a bonding pattern with approximately 17% bonded area.

An additional non-hydrophilic PLA spunbond was also used in some instances. This material had a basis weight of 36 grams per square meter and was made without surfactant. The web contained 0.3% of a polypropylene based blue masterbatch (PPM56160) purchased from Techmer Polymer Modifiers, Clinton, Tenn. The web was thermally bonded together with 17% bond area.

Additional substrates included a Nylon 6,6 spunbond web obtained from Cerex Advanced Fabrics, Inc. (Pensacola, Fla.) thermally bonded with a cross hatch pattern and a basis weight of 1.5 ounce per square yard. Two nonwoven webs from Suominen Nonwovens were evaluated. One was a polyester terapthalate spunlace material with a basis weight of 55 grams per square meter. The second was a multilayer construction containing a PET spunbond and a blend of wood pulp and PET staple fibers. This web had a basis weight of 45 grams per square meter.

Extrusion Coating onto Nonwoven

A 25-mm Haake twin-screw extruder was used for melt blending and cast film coating extrusion onto the nonwoven substrate web. The INGEO PLA4032 resin, PLAM58162 blue mastertbatch, ECOPROMOTE masterbatch (20 wt-% in PLA4032) and various PLA anti-block masterbatch were dry blended together and fed into Zone 1 of the extruder. Polyvinyl acetate powder was fed into Zone 1 of the extruder, using a second feeder. CITROFLEX A4 plasticizer was fed into Zone 3 of the extruder. Vacuum was applied at Zone 4 of the extruder. The polymer melt was extrusion coated onto PLA nonwovens through a drop die to form a thin film with a thickness of 0.6 to 1 mil. The unit of measure of “mil” is equal to 0.001 inch or 25.4 micrometers.

TABLE 2
Coating extrusion conditions

| Film composition | INGEO 4032D/PLAM58162/SUKANO NA S516/VINAVIL K70/ | | | | | |
|---|---|---|---|---|---|---|
| | CITROFLEX A4 | | | | | |
| | (40/10/2/30/18 wt-%) | | | | | |
| Film thickness | 0.7 mil (~18 micrometers) | | | | | |
| Total feed rate | 6.6 lbs/hr (~3.0 kg/hr) | | | | | |
| Screw speed | 300 RPM | | | | | |
| Line speed | 20 feet/min (~6 m/min) | | | | | |
| Extruder temperature | Zone 1 | Zone 2 | Zone 3 | Zone 4 | Zone 5 | Zone 6 |
| | 200° F. | 300° F. | 350° F. | 350° F. | 350° F. | 350° F. |
| | (~93° C.) | (~149° C.) | (~177° C.) | (~177° C.) | (~177° C.) | (~177° C.) |

| | |
|---|---|
| Neck tube temperature | 400° F. |
| | (~204° C.) |
| Die temperature | 400° F. |
| | (~204° C.) |
| Rubber nip roll (film | Warm (no temperature control) |
| side) temperature | |
| Back steel nip roll | 175° F. |
| (nonwoven side) | (~79° C.) |
| temperature | |

Unless otherwise noted, amounts of material are listed by weight, or by weight percent (“wt-%”), and, “~” means approximately.

### Examples 1-13

Example 1 was prepared by extrusion coating a 30 gsm hydrophilic PLA nonwoven with a film made with the following formulation (all % by weight): 46.8% PLA 4032D, 35% VINNAPAS UW 4, 18% CITROFLEX A-4, 0.2% ECOPROMOTE. This formulation was processed at approximately 400° F. and coated with a coat weight of approximately 24 grams per square meter (gsm). Examples 2-13 were prepared in a similar fashion to Example 1, with changes to the film composition, film thickness and nonwoven grams per square meter weight, as described in Table 3.

TABLE 3
EXAMPLES 1-13

| | | | | Hydrohead (mbar) |
|---|---|---|---|---|
| | | Film | | (Prior to EO |
| | Film composition | thickness | Nonwoven | sterilization at |
| EX. | (wt-%) | (mil) | (gsm) | 60 mbar/minute) |
| 1 | PLA4032/VINNAPAS UW | 0.8 | 30 | 180 |
| | 4/CITROFLEX A4/ECOPROMOTE | | | |
| | (46.8/35/18/0.2) | | | |
| 2 | PLA4032/VINNAPAS UW | 0.8 | 30 | 214 |
| | 4/CITROFLEX A4/ECOPROMOTE | | | |
| | (54.7/25/20/0.3) | | | |
| 3 | PLA4032/VINNAPAS UW | 0.8 | 30 | 187 |
| | 4/CITROFLEX A4/ECOPROMOTE | | | |
| | (49.8/30/20/0.2) | | | |
| 4 | PLA4032/PLAM58162/VINAVIL K70/ | 0.7 | 48 | 227 |
| | CITROFLEX A4/SUKANO NA S516 | | | |
| | (40/10/30/18/2) | | | |
| 5 | PLA4032/PLAM58162/VINAVIL K70/ | 0.6 | 48 | 218 |
| | CITROFLEX A4/SUKANO NA S516 | | | |
| | (38/10/30/18/4) | | | |
| 6 | PLA4032/PLAM58162/VINAVIL K70/ | 0.6 | 48 | 224 |
| | CITROFLEX A4/SUKANO NA S516/ | | | |
| | SUKANO DC S709 | | | |
| | (35/10/30/18/2/5) | | | |
| 7 | PLA4032/PLAM58162/VINAVIL K70/ | 0.7 | 48 | 216 |
| | CITROFLEX A4/SUKANO NA S516/ | | | |
| | CLARIANT DE MB | | | |
| | (35/10/30/18/2/5) | | | |
| 8 | PLA4032/PLAM58162/VINAVIL K70/ | 0.7 | 48 | 214 |
| | CITROFLEX A4/SUKANO NA S516/ | | | |
| | CLARIANT CaCO3 MB | | | |
| | (35/10/30/18/2/5) | | | |
| 9 | PLA4032/PLAM58162/VINAVIL K70/ | 0.7 | 48 | 185 |
| | CITROFLEX A4/SUKANO DC S511/ | | | |
| | CLARIANT DE MB | | | |
| | (38/10/30/18/2/2) | | | |
| 10 | PLA4032/PLAM58162/VINAVIL K70/ | 0.6 | 48 | 230 |
| | CITROFLEX A4/SUKANO DC S511/ | | | |
| | CLARIANT DE MB | | | |
| | (35/10/30/18/2/5) | | | |
| 11 | PLA4032/PLAM58162/VINAVIL K70/ | 0.7 | 48 | 179 |
| | CITROFLEX A4/SUKANO DC S511/ | | | |
| | CLARIANT CaCO3 MB | | | |
| | (38/10/30/18/2/2) | | | |
| 12 | PLA4032/PLAM58162/VINAVIL K70/ | 0.7 | 48 | 203 |
| | CITROFLEX A4/SUKANO DC S511/ | | | |
| | CLARIANT CaCO3 MB | | | |
| | (35/10/30/18/2/5) | | | |
| 13 | PLA4032/PLAM58162/VINAVIL K70/ | 0.8 | 48 | 205 |
| | CITROFLEX A4/SUKANO DC S511/ | | | |
| | SUKANO DC S709 | | | |
| | (35/10/30/18/2/5) | | | |

### Example 14

The hydrophilic PLA nonwoven was coated with a film made with the following formulation (all % by weight): 49% PLA #1, 30% PVAC #2, 18% CITROFLEX A-4, 2% SUKANO S516, and 1% of pre-compounded ECOPROMOTE (20% concentration in 4032D). This formulation was processed at approximately 400° F. and coated with a coat weight of approximately 22 grams per square meter (gsm).

### Example 15

Example 15 was made with a similar formulation as Example 14, however, the PLA #2 was used. Because of the change in the base PLA for this example, the melt temperature targeted was approximately 350° F. The resulting coat weight was 38 gsm.

### Example 16

Example 16 used PBS rather than the 49% PLA. The PBS required a lower melting temperature. The melt temperature targeted was approximately 300° F. The coat weight was 36 gsm.

### Example 17

Example 17 utilized the following film formulation (% by Weight): 57.4% PLA #1, 24.6% PVAC-L, 15% CITROFLEX A-4, 2% SUKANO S516, and 1% of pre-compounded ECOPROMOTE (20% concentration in 4032D). This example was coated on the hydrophilic PLA nonwoven described above. A melt temperature of approximately 400° F. was targeted. The resulting coat weight was approximately 28 gsm.

### Example 18

Example 18 used 57.4% PBS, rather than the PLA #1, 24.6% PVAC-L, 15% CITROFLEX A-4, 2% SUKANO S516, and 1% of pre-compounded ECOPROMOTE (20% concentration in 4032D). For this example, the melt temperature targeted was approximately 300° F., the coat weight came in at 40 gsm.

### Examples 19-20

Examples 19-20 were run for comparison with varying levels of PVAC-L. Examples 19-20 were prepared in the same manner described above except with the following changes. Example 19 was made using 80% PLA #1 and 20% PVAC-L. Example 20 was made using 70% PLA #1 and 30% PVAC-L. Both examples targeted a melt temperature of approximately 400° F. Examples 19 and 20 were coated directly onto the non-treated side of the hydrophilic PLA-based nonwoven previously described. Both had coat weights of approximately 27 gsm.

### Example 21

Example 21 was for comparison of a plasticized version of Example 20. Example 21 was formulated with 59.5% PLA #1, 25.5% PVAC-L and 15% CITROFLEX A-4. Example 21 was made with an approximate melt temperature of 400° F. and coat weight of approximately 27 gsm. Examples 21 was coated directly onto the non-treated side of the hydrophilic PLA-based nonwoven previously described.

### Example 22

Example 22 was formulated using 59.5% PLA #1, 25.5% PVAC-L, 10% PEG3350, and 5% of a 20% concentration masterbatch of ECOPROMOTE in PLA #1. Example 22 was coated on the non-treated side of the hydrophilic PLA based nonwoven at a melt temperature of approximately 400° F. at a coat weight of 32 gsm

### Example 23 (Comparative)

Example 23 was formulated with 80% PLA #1 and 20% CITROFLEX A-4 and was processed at an approximate melt temperature of 400° F. and coated directly onto the non-treated side of the hydrophilic PLA nonwoven with a coat weight of approximately 28 gsm. Additional samples were made for comparison.

### Example 24 (Comparative)

Example 24 was formulated with 80% PLA #2 and 20% CITROFLEX A-4 and was processed at an approximate melt temperature of 350° F. and coated at a weight of approximately 34 gsm directly onto the non-treated side of the hydrophilic PLA-based nonwoven.

### Example 25 (Comparative)

Example 25 was formulated with 79% PLA #1, 20% CITROFLEX A-4, and 1% of pre-compounded ECOPROMOTE (20% concentration in 4032D) and coated at approximately 30 gsm on the non-treated side of the hydrophilic PLA nonwoven.

### Example 26 (Comparative)

Example 26 was formulated with 78% PLA #2, 20% CITROFLEX A-4, and 2% SUKANO S516 and was coated onto the non-treated side of the hydrophilic PLA nonwoven at an approximate melt temperature of 350° F. and a coat weight of 27 gsm.

### Example 27 (Comparative)

For Example 27, the non-treated side of the previously described hydrophilic PLA nonwoven was coated with a film consisting of 83.6% PLA #2 and 16.4% CLARIANT 4060SF. The resulting formulation was 95.9% PLA #2 and 4.1% SUPERFLOSS.

### Example 28 (Comparative)

Example 28 consisted of 92% CLARIANT 4060UT and 8% of PLA #2. The film had a composition of 77% PLA #2 and 23% Ultratalc 609 was coated onto the non-treated side of the hydrophilic PLA nonwoven with an approximate melt temperature of 350° F. with a coat weight of 29 gsm.

### Example 29 (Comparative)

Example 29 consisted of 89% PLA #1, 5% PLA #3, 5% PEG3350, and 4% CLARIANT 4032 UT. Example 29 was produced at an approximate melt temperature of 400° F. and was coated onto the non-treated side of the hydrophilic PLA nonwoven at a coat weight of 32 gsm.

### Example 30 (Comparative)

Example 30 was formulated with 80% PLA #1, 5% PLA #3, 10% PEG3350, and 5% of a masterbatch containing 20% Ecopromote. Example 29 was produced at an approximate melt temperature of 400° F. and was coated at a coat weight of 30 gsm onto the non-treated side of the hydrophilic PLA nonwoven.

### Alternative Nonwoven Substrates

### Example 31

Example 31 was a coating of the formulation used in Example 14 (49% PLA #1, 30% PVAC #2, 18% CITROFLEX A-4, 2% SUKANO S516, and 1% of pre-compounded ECOPROMOTE (20%)) onto a non-hydrophilic PLA nonwoven.

### Example 32

Example 32 was a coating of the formulation used in Example 14 (49% PLA #1, 30% PVAC #2, 18% CITROFLEX A-4, 2% SUKANO S516, and 1% of pre-compounded ECOPROMOTE (20%)) onto a CEREX PBII 30150 (Nylon 6,6) nonwoven.

### Example 33

Example 33 was a coating of the formulation used in Example 14 (49% PLA #1, 30% PVAC #2, 18% CITROFLEX A-4, 2% SUKANO S516, and 1% of pre-compounded ECOPROMOTE (20%)) onto a SUOMINEN SX-776 (PET) nonwoven.

### Example 34

Example 34 was a coating of the formulation used in Example 14 (49% PLA #1, 30% PVAC #2, 18% CITROFLEX A-4, 2% SUKANO S516, and 1% of pre-compounded ECOPROMOTE (20%)) onto a SUOMINEN wood pulp/PET nonwoven. Melt temperatures and coat weights were held consistent with those used to produce example 14.

### Example 35

Example 35 was a coating of the formation used in Example 15 (49% PLA #2, 30% PVAC #2, 18% CITROFLEX A-4, 2% SUKANO S516, and 1% of pre-compounded ECOPROMOTE (20%)) onto a non-hydrophilic PLA nonwoven.

### Example 36

Example 36 was a coating of the formation used in Example 15 (49% PLA #2, 30% PVAC #2, 18% CITROFLEX A-4, 2% SUKANO S516, and 1% of pre-compounded ECOPROMOTE (20%)) onto the CEREX PBII 30150 (Nylon 6,6) nonwoven.

### Example 37

Example 37 was a coating of the formation used in Example 15 (49% PLA #2, 30% PVAC #2, 18% CITROFLEX A-4, 2% SUKANO S516, and 1% of pre-compounded ECOPROMOTE (20%)) onto the SUOMINEN SX-776 nonwoven.

### Example 38

Example 38 was a coating of the formation used in Example 15 (49% PLA #2, 30% PVAC #2, 18% CITROFLEX A-4, 2% SUKANO S516, and 1% of pre-compounded ECOPROMOTE (20%)) onto the SUOMINEN wood pulp/PET nonwoven.

### Example 39

Example 39 was a coating of the formulation used in Example 16 (49% PBS, 30% PVAC #2, 18% CITROFLEX A-4, 2% SUKANO S516, and 1% of pre-compounded ECOPROMOTE (20%)) onto the non-hydrophilic PLA nonwoven.

TABLE 4
Test Results

| | | Hydrohead | Hydrohead | | | | |
|---|---|---|---|---|---|---|---|
| | Coating | (Prior to EO | (Post EO | Stiffness by | | Ink | |
| | Weight | Sterilized) | Sterilized) | Circular Bend | Blocking | Migration | Noise |
| EX. | (gsm) | (mbar) | (mbar) | (N) | Test | Test | Test |
| 1 | 24.3 | 180 | NT | NT | NT | NT | NT |
| 2 | 24.3 | 214 | NT | NT | NT | NT | NT |
| 3 | 24.3 | 187 | NT | NT | NT | NT | NT |
| 4 | 20.9 | 227 | 149 | 3.2 | 0 | Pass | 1 |
| 5 | 18.4 | 218 | 140 | 3.3 | 0 | Pass | 1 |
| 6 | 19.3 | 224 | 157 | 3.8 | 1 | Pass | 1 |
| 7 | 20.9 | 216 | 145 | 4.3 | 0 | Pass | 2 |
| 8 | 20.9 | 214 | 154 | 4.0 | 0 | Pass | 2 |
| 9 | 20.9 | 185 | 152 | 3.6 | 1 | Pass | 1 |
| 10 | 17.6 | 230 | 145 | 3.6 | 1 | Pass | 1 |
| 11 | 20.9 | 179 | 137 | 3.2 | 0 | Pass | 1 |
| 12 | 20.9 | 203 | 144 | 3.8 | 0 | Pass | 1 |
| 13 | 24.3 | 205 | 187 | 3.7 | 0 | Pass | 1 |
| 14 | 21.8 | 212 | NT | 3.4 | 1 | Pass | 2 |
| 15 | 37.7 | 207 | NT | 6.4 | 3 | Pass | 2 |
| 16 | 36.0 | NT | NT | 6.4 | 1 | Pass | 2 |
| 17 | 24.3 | 238 | NT | 4.7 | 0 | Pass | 3 |
| 18 | 39.3 | * | NT | 7.7 | NT | Pass | 4 |
| 19 | 27.2 | 90 | NT | 7.8 | 2 | Pass | 5 |
| 20 | 27.2 | 148 | NT | 7.4 | 2 | Pass | 5 |
| 21 | 26.8 | 249 | NT | 5.6 | 1 | Pass | 4 |
| 22 | 31.8 | 351 | NT | 6.2 | 1 | Pass | 5 |
| 23 | 27.6 | 247 | NT | 4.0 | 0 | Fail | 2 |
| 24 | 33.5 | 271 | NT | 5.6 | 3 | Pass | 2 |
| 25 | 30.1 | 288 | NT | 4.2 | 0 | Fail | 2 |
| 26 | 27.2 | 323 | NT | 5.7 | 3 | Pass | 2 |
| 27 | 25.1 | 87 | NT | 6.7 | 2 | Pass | 5 |
| 28 | 28.5 | 79 | NT | 8.3 | 2 | Pass | 5 |
| 29 | 31.8 | 136 | NT | 8.9 | 1 | Pass | 5 |
| 30 | 29.7 | 272 | NT | 6.6 | 1 | Pass | 5 |
| 31 | 22 | 212 | NT | 3.4 | NT | NT | NT |
| 32 | 22 | 26 | NT | 3.3 | NT | NT | NT |
| 33 | 22 | 37 | NT | 1.5 | NT | NT | NT |
| 34 | 22 | 46 | NT | 2.8 | NT | NT | NT |
| 35 | 38 | 181 | NT | 3.8 | NT | NT | NT |
| 36 | 38 | 33 | NT | 5.3 | NT | NT | NT |
| 37 | 38 | 91 | NT | 2.9 | NT | NT | NT |
| 38 | 38 | 173 | NT | 4.2 | NT | NT | NT |
| 39 | 36 | 11 | NT | 3.8 | NT | NT | NT |

(NT = Not Tested)
(* Testing error, results incomplete at this time.)

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A multilayer article comprising:
a fibrous web comprising fibers comprising natural fibers, synthetic fibers, or combinations thereof; wherein the synthetic fibers comprise a synthetic thermoplastic polymer selected from an aliphatic polyester, an aromatic polyester, a polyamide, and combinations thereof; and
a barrier film directly bonded to the fibrous web; wherein the barrier film comprises:
a thermoplastic aliphatic polyester;
a polyvinyl alkanoate polymer having a Tg of no greater than 70° C.; and
a non-lactide plasticizer having an acid number of no greater than 10 and having a weight average molecular weight of no greater than 5000 g/mol.

2. The multilayer article of claim 1, wherein the fibrous web is instantaneously absorbent to water.

3. The multilayer article of claim 1, wherein the fibrous web comprises fibers comprising a synthetic thermoplastic polymer.

4. The multilayer article of claim 3, wherein the thermoplastic polymer comprises an aliphatic polyester.

5. The multilayer article of claim 4, wherein the aliphatic polyester of the fibrous web is semicrystalline.

6. The multilayer article of claim 1, wherein the fibrous web further comprises a surfactant.

7. The multilayer article of claim 6, wherein the surfactant is incorporated in the synthetic polymer of the fibers.

8. The multilayer article of claim 6, wherein the surfactant is disposed on the fibers.

9. The multilayer article of claim 6, wherein the surfactant is disposed on the fibrous web.

10. The multilayer article of claim 9, wherein the fibrous web comprises a combination of a nonionic surfactant with an anionic surfactant or a zwitterionic surfactant.

11. The multilayer article of claim 8, wherein the fibrous web further comprises a nonvolatile surfactant carrier.

12. The multilayer article of claim 1, wherein the fibrous web further comprises a thermoplastic antishrinkage additive.

13. The multilayer article of claim 1, wherein the aliphatic polyester of the barrier film is semicrystalline.

14. The multilayer article of claim 1, wherein the polyvinyl alkanoate polymer has a weight average molecular weight of at least 75,000 g/mol and up to 750,000 g/mol.

15. The multilayer article of claim 1, wherein the barrier film further comprises a nucleating agent.

16. The multilayer article of claim 1, wherein the barrier film does not exhibit plasticizer migration when aged at 80° C. for 24 hours.

17. The multilayer article of claim 1, wherein the barrier film is directly bonded to the hydrophilic absorbent layer by thermal bonding.

18. The multilayer article of claim 1, wherein the barrier film has a net melting endotherm for a first heating scan, ΔHₙₘ₁, of greater than 10 J/g.

19. The multilayer article of claim 1, which is in the form of a surgical drape, a surgical gown, a sterilization wrap, or a patient warming device.

20. A method of making a multilayer article, the method comprising:
providing a fibrous web comprising fibers comprising natural fibers, synthetic fibers, or combinations thereof; wherein the synthetic fibers comprise a synthetic thermoplastic polymer selected from an aliphatic polyester, an aromatic polyester, a polyamide, and combinations thereof; and
directly bonding a barrier film to the fibrous web; wherein the barrier film comprises:
a thermoplastic aliphatic polyester; a polyvinyl alkanoate polymer having a Tg of at least −80° C.; and
a non-lactide plasticizer having an acid number of no greater than 10 and having a weight average molecular weight of no greater than 5000 g/mol.
